(19) United States
(12) Patent Application Publication
(10) Pub. No.: US 2012/0078906 A1
(43) Pub. Date: Mar. 29, 2012

(54) AUTOMATED GENERATION AND DISCOVERY OF USER PROFILES

(76) Inventors: Pankaj Anand, Cupertino, CA (US); Maxim Lukichev, Sunnyvale, CA (US); Puneet Trehan, Cupertino, CA (US); Sumit Vij, Santa Clara, CA (US); Nitin Arora, Cupertino, CA (US)

(21) Appl. No.: 13/197,711

(22) Filed: Aug. 3, 2011

Related U.S. Application Data
(60) Provisional application No. 61/370,423, filed on Aug. 3, 2010.

(51) Int. Cl. G06F 17/30

(52) U.S. Cl. 707/737; 707/741; 707/E17.059; 707/E17.083; 707/E17.089

(57) ABSTRACT

A robust knowledge-based management and sharing system organized by context for expertise-based or context-based searching and retrieval of relevant information is disclosed. The various embodiments and techniques described herein are used to organize a user's data and communications around the user's expertise or one or more contexts the user is associated with such as the user's projects, products, and customers. The organization of user data is derived from the user's competencies and interactions with others and is used to build and index user profiles in a manner that facilitates retrieval in search results for relevant search criteria. A linguistic processing pipeline is used to parse and index the user's data to generate the complete and partial profiles organized by context. Complete and partial profiles are generated, indexed, ranked, and stored by the system. Once a profile is built and indexed into the proper expertise or context(s), it can yield highly relevant results in searches for persons with a desired set of competencies, knowledge, experience, or connections in a particular context.

### PRIORITY

The present patent application claims priority to and incorporates by reference the corresponding provisional patent application no. 61/370,423, entitled, “Automated Generation and Discovery of User Profiles” filed on Aug. 3, 2010.

### FIELD OF THE INVENTION

At least certain embodiments of the invention relate generally to automated generation and searching of user profiles in electrical systems.

### BACKGROUND

In large organizations, communities, and networks people often communicate and collaborate with others they know or are directly connected to. But there are limited ways to search for or discover other people within a particular organization or community who are relevant to a current need that an individual may be interested in. Traditional search techniques look for high-level keywords or descriptions in an individual's user profile. These profiles must be manually updated by the user from time to time, which can be a time consuming and tedious activity. Since updating one's profile is a manual activity, a search for a particular individual's profile could obtain search results that are stale or no longer relevant.

### SUMMARY

Methods, apparatuses, and systems are disclosed for providing a robust knowledge-based management and sharing system organized by context for context-based searching and retrieval of relevant information is disclosed. The various embodiments and techniques described herein are used to organize users' data around one or more contexts the users are associated with such as their projects, products, and customers. The organization of user data is derived from the user's competencies and interactions with others and is used to build and index user profiles in a manner that facilitates retrieval in search results for relevant search criteria. A linguistic processing pipeline is used to parse and index users data to generate the complete and partial profiles organized by context. Complete and partial profiles are generated, indexed, ranked, and stored by the system. Once a profile is built and indexed into the proper expertise or context(s), it can yield highly relevant results in searches for persons with a desired set of competencies, knowledge, experience, or connections in a particular context.

### BRIEF DESCRIPTION OF THE DRAWINGS

For a better understanding of at least certain embodiments, reference will be made to the following Detailed Description, which is to be read in conjunction with the accompanying drawings, wherein:

FIG. 1A depicts an illustrative embodiment of an environment in which profile searching and indexing may be implemented.

FIG. 1B depicts illustrative physical or logical components for implementing profile searching and indexing.

FIG. 2A depicts an illustrative embodiment of a linguistic processing pipeline.

FIG. 2B depicts an illustrative embodiment of a linguistic parsing component.

FIG. 2C depicts an illustrative embodiment of a competency detection unit.

FIG. 2D depicts an illustrative embodiment of a statistical processing pipeline.

FIG. 2E depicts an illustrative embodiment of a scoring component.

FIG. 2F depicts an illustrative embodiment of a graph processing unit.

FIG. 2G depicts an illustrative embodiment of a process of generating user communities.

FIG. 2H depicts an illustrative embodiment of document mapping.

FIG. 2I depicts an illustrative embodiment of a process for generating a document community.

FIG. 2J depicts an illustrative embodiment of a process for generating groups of phases.

FIG. 2K depicts an illustrative embodiment of a recommendation unit.

FIG. 3 depicts an illustrative embodiment of a process of implementing profile indexing.

FIG. 4 depicts an illustrative embodiment of a process of implementing profile searching.

FIG. 5 depicts an illustrative embodiment of a process of implementing profile tracking.

FIGS. 6A-6G depict illustrative embodiments of a graphical user interface.

FIG. 7 depicts an illustrative embodiment of a data processing system upon which the methods and apparatuses of the invention may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

People in organizations, communities, and networks communicate using phone calls, emails, discussion forums, online social networking tools, and instant messengers. Apart from these communications, there are many other activities that can be done to find relevant information or people such as performing interne or intranet searches. These communications and activities, if analyzed properly using scientific and intelligent methods, can provide sufficient knowledge about the following aspects of a user or an organization: conversational behavior; information flow; organization's structure; commonly used organizational and group terminology; current projects; or other important aspects. This information can be effectively used to automatically create a user profile, which can be automatically updated from time to time in order to keep it relevant. Various embodiments described below include automatically creating and iteratively updating a user's profile based on information derived from various communications and activities of a user or organization. These embodiments also assist in providing suggestions about individuals who might be able to help or contribute to solving a problem based on what that individual is working on or looking for. In particular, the embodiments were developed to overcome a lack of effective search tools to find and automatically suggest relevant sets of people within an organization, community, or a network, in a specific context.

As used herein, the term “profile” refers to the set of keywords which defines a user's expertise, skills and experience, conversational behavior, and preferences. The term “profile age” refers to the score assigned to each profile based on a user's activity. A user's profile starts to age from the last point in time it was updated. If user activities such as the communications discussed above are discontinued, the user's profile starts to age. The keywords associated with that profile such as the user's experience or expertise starts to age also. The term “profile score” refers to a numeric tag including profile age and keyword weighting, which are assigned to each profile based on its various aspects as described below. A “starting profile score” refers to the base score of the profile at initialization. The higher the score, the more relevant the profile is. In one embodiment, this score is based on profile age and frequency of updates.

An aspect of a profile refers to the category of information gathered in the form of keywords or other structured data about a user. Aspects can be of three basic types, which are described herein for exemplary purposes only and are not intended to limit to any particular type or quantity of aspects. Additional and different aspects can be added and applied within the system dynamically. The types of aspects may include a user's knowledge, his or her communications, and the user's connections with other persons or entities. The knowledge aspect can be used as a category to indicate the expertise and experience of a user in various areas or fields of endeavor. The communication aspect can be used as a category of information to indicate the communication behavior of a user, e.g., preferred communication mode, degree of communication, or interaction pattern of a user. The connection aspect can be used as a category to indicate the proximity of the user's profile to a certain criteria that can be searched, for example, by other users of the system. This proximity is calculated based on the connection strength and hops between users. Every user profile can be evaluated and ranked after placing it in one or more of these aspects. Top ranked profiles form the suggestion pool for a given context and search criteria.

As used herein, the term “complete profile” refers to a complete set of information obtained from automatically indexing a user's emails, documents, phone calls, instant messages, meeting invites, calendar, and other related information stored in and retrieved from that user's computer, PDA, smartphone, or web applications, etc. This profile may be created using all the communications and interactions the user has with others, and also by using co-learning techniques where a user can manually enter or correct automatically generated profile information. The term “partial profile,” on the other hand, refers to an incomplete set of information obtained about the individuals a user interacts with from automatic retrieving and indexing of that individual's emails, documents, phone calls, instant messages, meeting invites, calendar, and other related information. Complete profiles are built for users of the system, and partial profiles are built of the individuals this user interacts with. These partial profiles are created for individuals who are not registered users or who are not part of the system, and who are identified from their communications or interactions with a system user. Since a partial profile can only represent a limited amount of information about the skills and expertise of the individual, all partial profiles of a user from various interacting users are collected on the server to build the partial profile of that user.

The term “profile views” refers to representations of profiles with respect to the purposes and interests of users. Administrators, managers, and users may have different purposes when viewing a profile. In at least certain embodiments, there are three types of profile views: (1) user-centric profiles; (2) usage-centric profiles; and (3) management-centric profiles. This is given by way of illustration and not a limitation, as more or fewer profile views may be included in the system described herein without deviating from the underlying principles of the disclosed techniques. The term “user-centric profile” refers to a profile view containing attributes that are important for the user, and are organized using keywords focused on the user's priorities or interests. The term “usage-centric profile” refers to a profile view containing attributes and other team-driven parameters such as compare the level of experience, number of new connections to the system, helpfulness to the issue at hand, etc. The term “management-centric profile” refers to a profile view containing attributes and filters to be used by management or human resources to take an inventory of expertise within a company or organization.

As used herein, the term “keyword” refers to a word or phrase relating to an atomic and relevant concept. Keywords can be used to define the skill, expertise, interest or behavior of users. In at least certain embodiments, keywords are categorized into three types including broad, functional, or narrow. Broad keywords are generally used by organizations or communities, while functional keywords may only be used by teams or large groups within an organization or community. Narrow keywords are generally used by smaller groups of people. This categorization assists the user in understanding team and organizational structures and group profiles working together within a team.

The term “keyword weighting” is used to refer to the importance and relevance of the keyword. Weighting is assigned to keywords based on various factors such as activities or communication relating to that keyword, temporal relevance, or organizational or group-wide usage of that keyword. Each keyword is allocated a weighting to rank profiles that match a particular context the user is interested in. The term “context” refers to the current frame of reference that a user intends to search for. Or in other words, the basis on which other user's profiles are searched, suggested, or listed. A set of keywords are combined together to create a context. The keyword can be used to create a context and also to match a user's profile against a specific context during a search. The process of generating user profiles uses a set of keywords that assists in indexing and matching user profiles with a specific context that can be subsequently searched by users. The term “profile rank” refers to the relevance of a profile in terms of the closest match with a specific context. A profile rank is specific to a particular context, and can be dynamically calculated if the context changes. Profile rank assists in providing the best matched profiles first to users when profiles are searched.

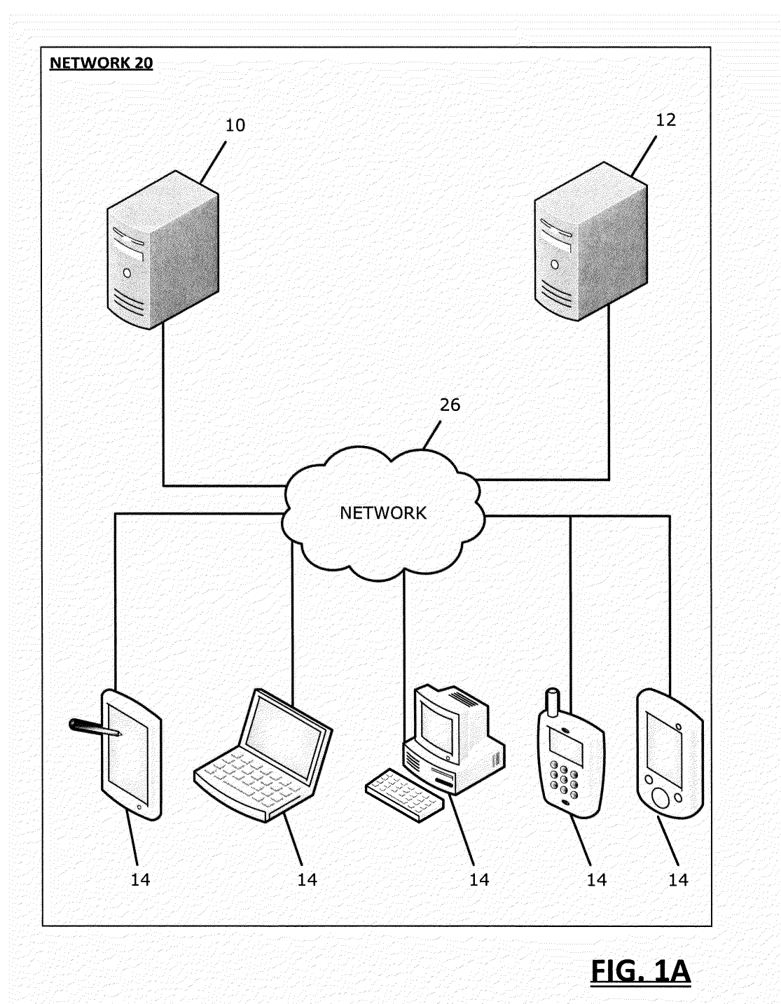

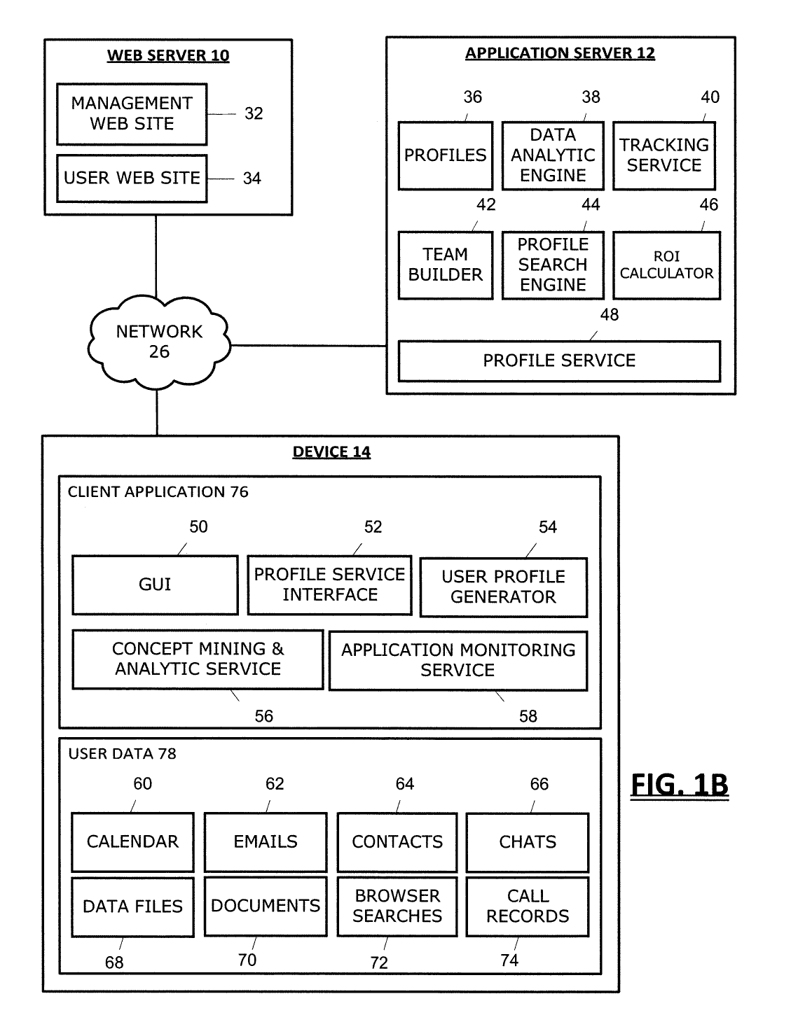

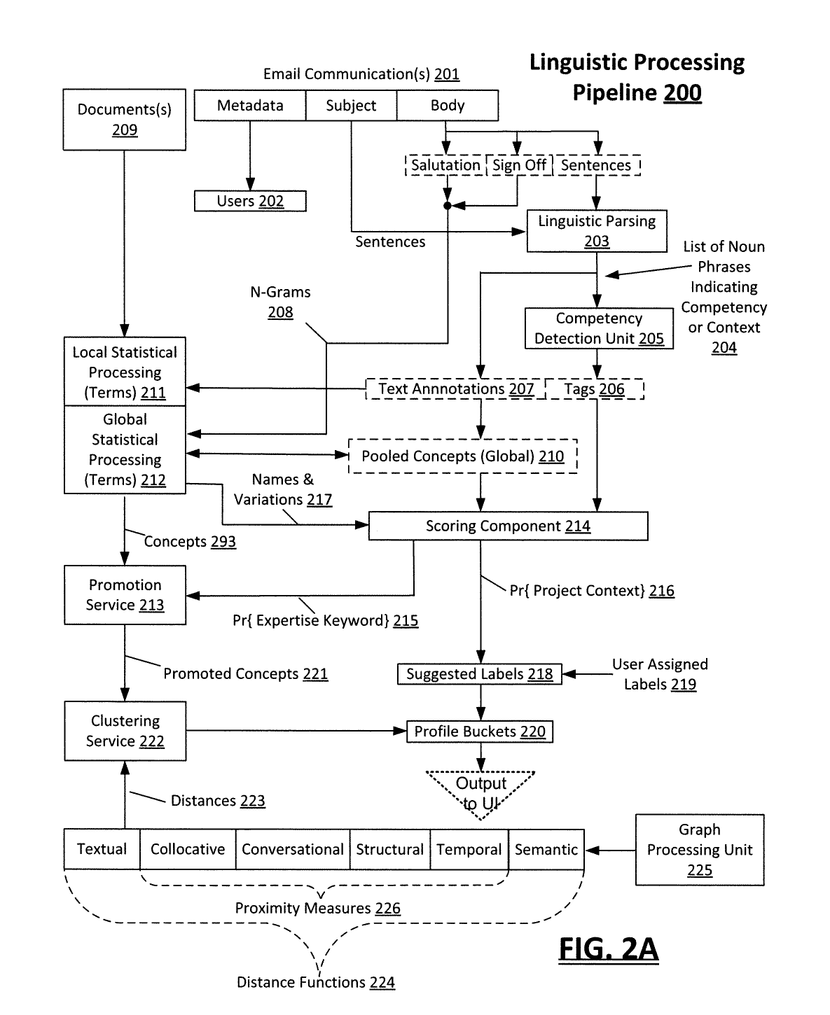

FIG. 1A depicts an exemplary network 20 in which various embodiments may be implemented. In the illustrated embodiment, network 20 includes various clients 14, web server 10, and an application server 14. Web server 10 configured to provide a website for user profile management. Application server 12 represents a network server configured to operate with clients 14, where client applications can submit user profile information or profile information about other individuals the user interacts with. Clients 14 include computing devices configured to interact with, and submit and receive profile information to and from application server 12. These clients 14 include internet enabled devices capable of running well-known applications for business or personal use such as email, instant messages, calendars, meetings, internet browsing, phone calls, etc. Clients 14 can include computers, laptops, PDAs, smartphones, mobile phones, etc. Network 20 may include any number of such devices and servers, and is not limited to the number depicted in FIG. 1A. Further, while servers 10 and 12 are depicted as being distinct, servers 10 and 12 may instead be implemented in a more integrated fashion. For example, web server 10 and application server 12 may represent a common server or collection of servers configured to implement the specified functions.

Components 10, 12 and 14 are interconnected via network 26. Network 26 may represent a direct or indirect electrical connection such a cable, wireless, fiber optic, or remote connection over a telecommunication network, infrared link, radio frequency link, or any other network connection or system that provides electronic communication. Network 26 may include intermediate proxies, routers, switches, load balancers, and the like. Paths followed by network 26 between components 10-14 as depicted in FIG. 1A may represent physical or logical connections between these devices.

FIG. 1B depicts various physical and logical components for implementing various embodiments according to an illustrative embodiment of the invention. In the illustrated embodiment, client 14 is shown to include a graphical user interface 50, profile service interface 52, user profile generator 54, concept mining and analytical service 56, and an application monitoring service 58. These components together form a client application 76. Graphical user interface 50 represents the user interface that contains profile information and a mechanism to control and manage various features of the client application. Profile service interface 52 represents generally any combination of hardware, software, or firmware configured to facilitate communications via network 26. For instance, interface 52 may include one or more physical ports such as a wired or wireless network ports over which communications may be sent and received on one or more data channels.

Client application 76 represents generally any combination of hardware, software, or firmware configured to process communications sent and received over interface 52. As addressed in more detail below, user profile generator 54 is responsible for processing and generating profile information of different types (partial and complete) based on the data collected by concept mining and analytical service 56. In at least certain embodiments, concept mining and analytical service 56 reads and processes user data 78 residing on client 14 or that is communicated over the network 26. Concept mining and analytical service 56 processes this user data 78 and creates lists of keywords and concepts found in that data. User profile generator 54 uses this data to create a user's complete profile or the partial profiles of other users.

Application monitoring service 58 provides information about changes made to any application or user data 78 residing on client 14. For example, where client 14 is a computer being used by user A and the user data includes email messages, application monitoring service 58 signals concept mining and analytical service 56 upon arrival of new email. Concept mining and analytical service 56 reads the newly arrived email and creates a list of possible concepts along with the people included in that email. If a user B sends an email to user A and the email discusses marketing ideas for new project called “PROJECT ABACUS,” for example, then concept mining and analytical service 56 reads and generates concepts such as marketing, project abacus, and others along with both user's interests. This enables user profile generator 54 to update user A's complete profile and create or update user B's partial profile. These profile updates are then submitted to the application server 12 using profile service interface 52.

As shown in the illustrated embodiment of FIG. 1B, user data 78 may include one or more of a calendar 60, emails 62, contacts 64, chats 66, data files 68, documents 70, browser searches 72, or call records 74. User data 78 represents the information about users' communications or interactions with other users, or any other information which signifies the user's expertise, interest, skills and behavior. User data 78 is shown to have several main components, but user data 78 may include any other component or information required to build a user's profile. For example, calendar 60 may include information such as a user's meetings, agenda, notes, attendees, to-do lists, birthdays, anniversaries, holidays, locations, organizer information, or presence status. Emails 62 represents electronic mail communication including, but not limited to, a message, subject, one or more attachments, recipients list, sender information, etc. Chats 66 may include instant messages, text messages, Facebook mail, messages or chats, Google+messages, Twitter updates, LinkedIn status updates, or visual or multi-media messages, etc. Documents 70 may represent textual or other types of documents such as spreadsheets, presentations, or photos on the user's device. Data files 68 may represent files such as databases files or XML files which contain information about a user's interests, skills, expertise or behavior. Browser searches 72 may represent information about the search history of a user in the network browser. Call records 74 may contain information about the voice or video calls made from or to a user's device, including, but not limited to, Skype interactions. These records can also contain the actual data of the calls including recorded voice or video messages.

In FIG. 1B, server 10 represents generally any combination of hardware, software, or firmware configured to host a secure graphical user interface to assist in managing and searching profiles, viewing management dashboards, and controlling features of client 14 and application servers 10 and 12. Server 10 in particular may include a graphical user interface to assist in managing and viewing features of the client application 76 and application server 12. While web server 10 currently shows two websites, it can include any number of such websites to provide the graphical user interface to users. It may include a management website 32 which can be used by administrators or authorized managers of an organization or community. In one embodiment, management website 32 represents a graphical user interface for managing the features of client application 76, application server 12, and other administrative tasks such as reports, security and audit control, etc. User website 34 allows users to view and search a particular user's profile or manage their own profile.

Application server 12 represents generally any combination of hardware, software, or firmware configured to receive requests from profile service interface 52, process those requests, and to return a response to profile service interface 52. Server 12 may include a combination of one or more server applications 30 or other such applications. In the illustrated embodiment, the server applications include profiles 36, data analytic engine 38, tracking service 40, team builder 42, profile search engine 44, return on investment (“ROI”) calculator 46, and profile service 48. Profile service 48 represents a network interface for clients 14 and web server 10, which can be used for profile submission, query, and retrieval. Profile service interface 52 in client 14 uses profile service 48 to submit complete or partial profiles, search profiles of the organization or community, or submit tracking requests. For example, in processing a profile request from profile service interface 52, profile service 48 forwards the profile information included in the request to data analytical engine 38 which removes noise (unwanted or common keywords) from the profile (complete or partial). Furthermore, server 12 may also employ team builder 42 to gain more information about the team a particular user belongs to. In this embodiment, the user profiles are updated in the profiles database 36. Server 12 may also access additional information about the same user profile submitted by other users or devices. Upon successful update of a profile, a response is sent to the client 14. Also, if there is a profile update available for the client 14, the same response can also contain the new profile information of that user.

In this embodiment, profiles database 36 contains information about organizations or communities, teams, and users. In particular, it may contain one or more of an organization profile, team profile, or user profile. Data analytic engine 38 represents combinations of scientific algorithms for removing noise from profiles, re-factor profile information, and deduce knowledge from information submitted by the client applications 76 about the user's expertise, interests, skills and behavior. Data analytic engine also runs complex algorithms to obtain historic data and trends about users, organizations, and teams.

Tracking service 40 allows users to receive profile recommendations matching the context they provided. Users can submit a context, or other collection of keywords, as “tracked keywords” to the profile service 48. Tracking service 40 keeps track of this context and notifies the user using profile service interface 52 when profiles matching that context are found on the application server 12. Tracking service 40 may also continuously monitor profile database 36 for updates. Team builder 42 is another abstract service that works in conjunction with data analytic service 38 and profiles database 36. Team builder 42 can group certain profiles into teams or groups based on their expertise and communication behavior. Since new and updated profile information is continuously submitted to the application server 12 by client applications 76, team builder 42 may be queried to obtain current teams and groups within or across organizations or communities. Profile search engine 44 is configured to match profiles based on the context provided by users. ROI calculator 46 represents a service that is configured to calculate any changes in communication pattern, amount of time saved, or new connections made before and after use of this system. It can calculate and communicate the benefits of using this service in business terms, including, but not limited to, resulting change in revenues and profits of the organization using this system.

One illustrative advantage of the techniques described herein is to organize users' lives and all their data around their projects, products, and customers based on their competencies and interactions with others and to build and index their profiles such that they can be easily found in relevant search results. Complete and partial profiles are generated and stored by the system, and indexed in a manner to facilitate retrieval in search results for relevant search criteria. This is done using a linguistic processing pipeline to parse and index users' data to generate complete and partial profiles organized by context. Once a profile is properly built and indexed into the proper context(s), it can be easily found with the relevant search criteria, yielding highly relevant results in searches for persons with a desired set of core competencies or connections. This enables a more robust knowledge-based management and sharing system organized by communities for community-based searching and for retrieval of relevant information.

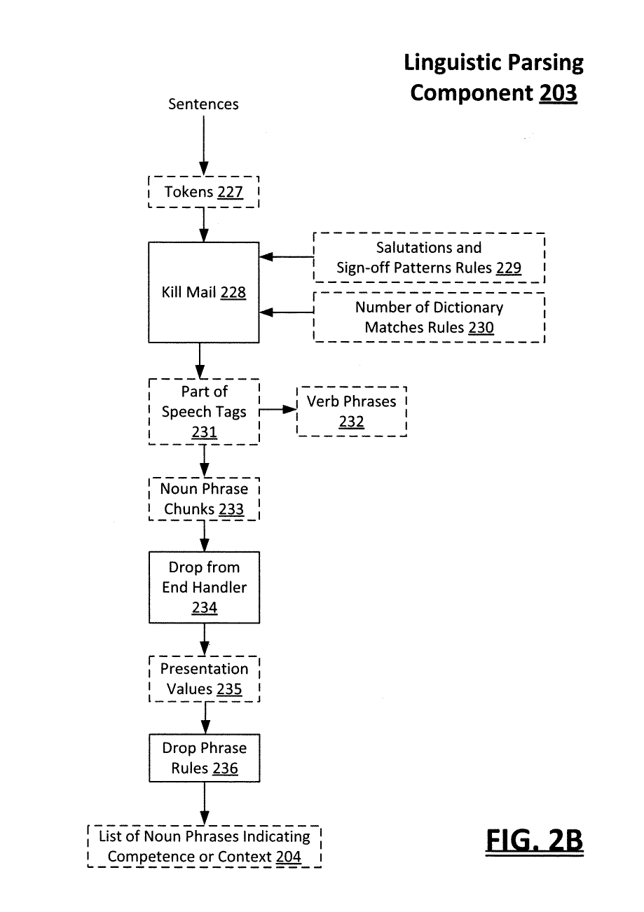

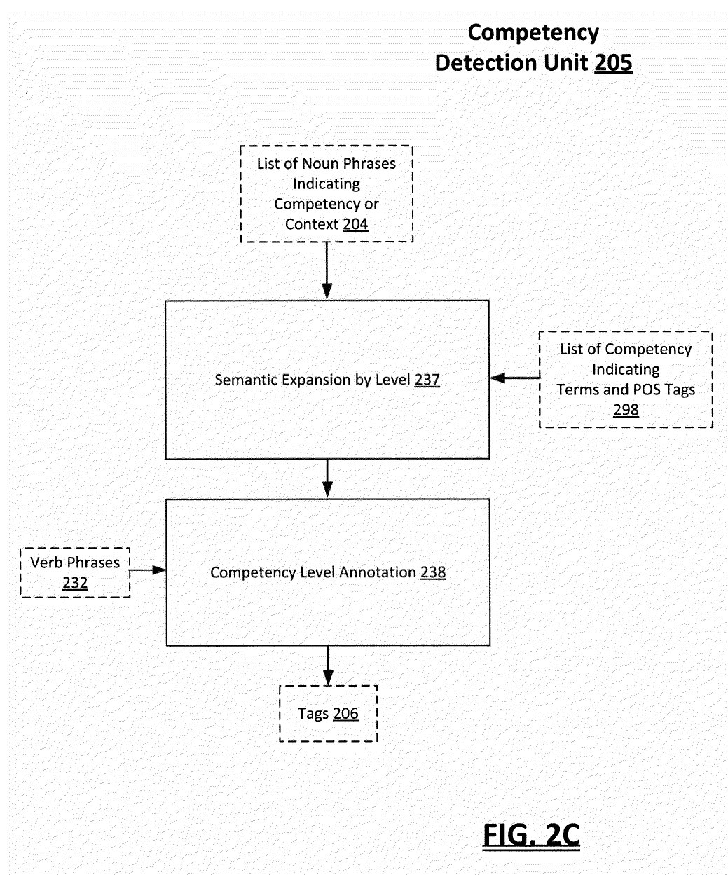

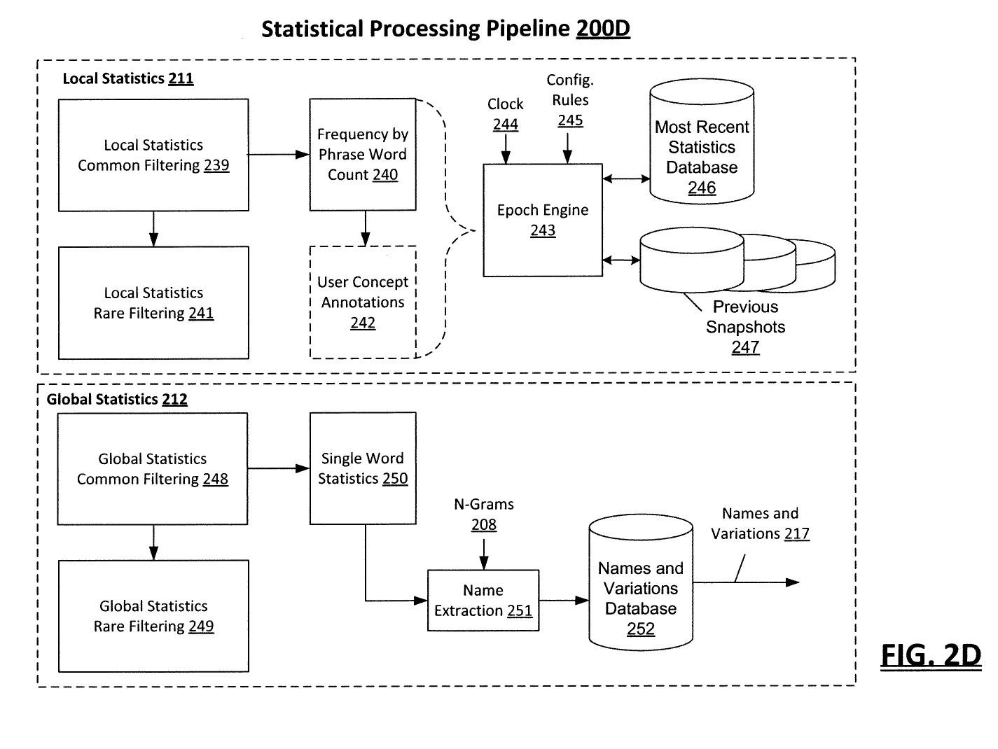

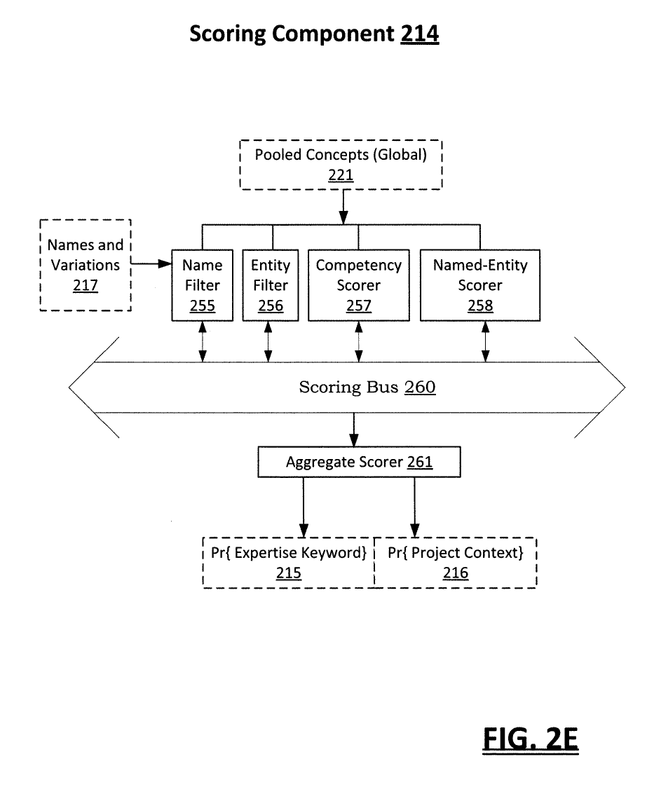

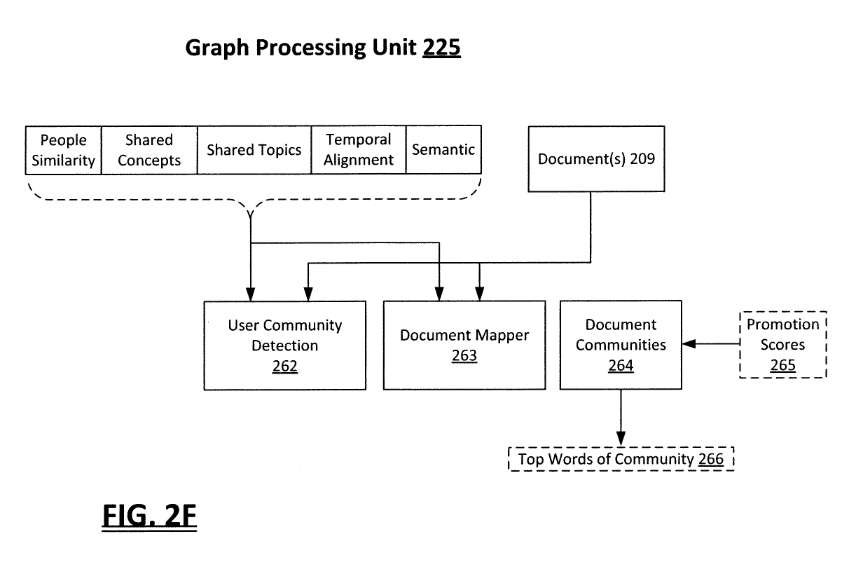

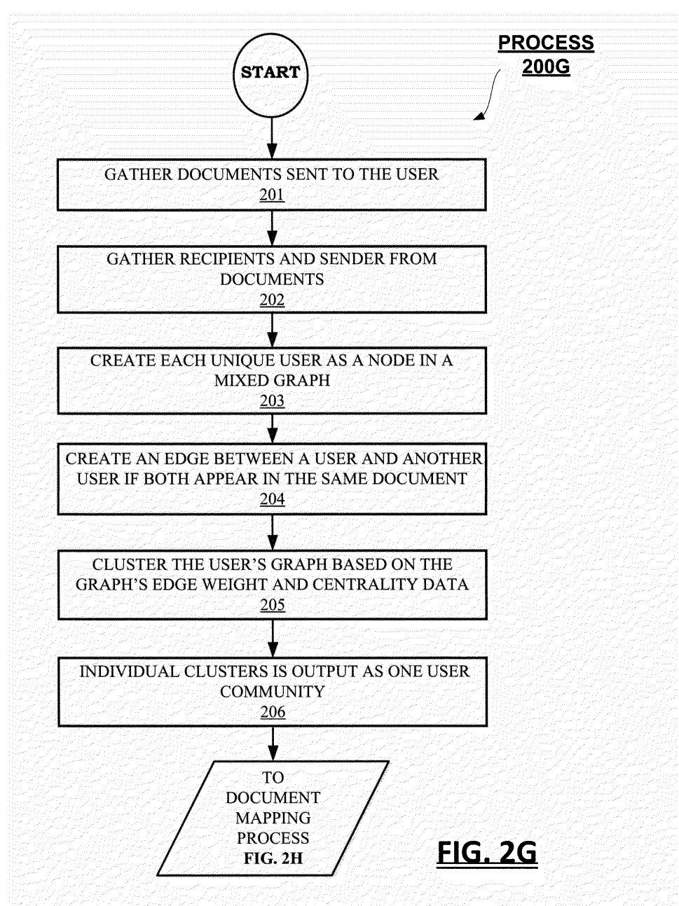

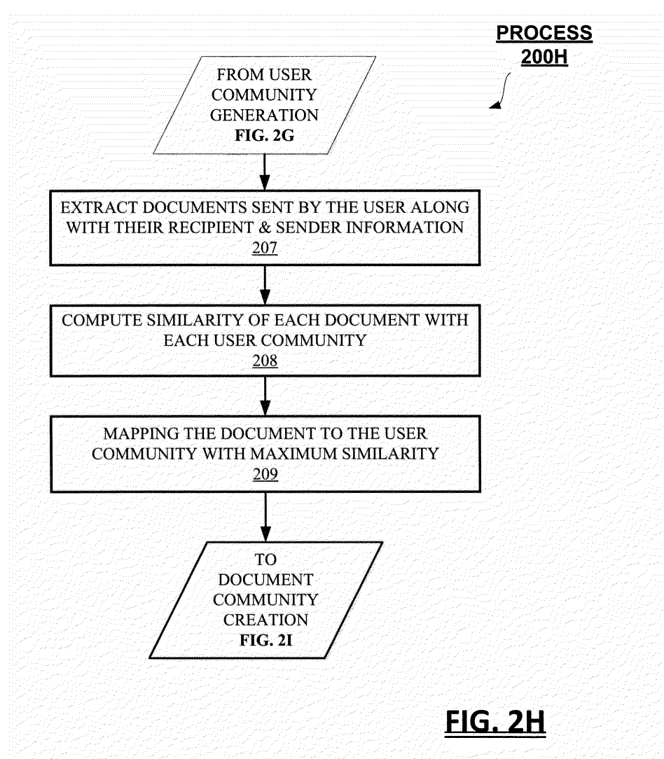

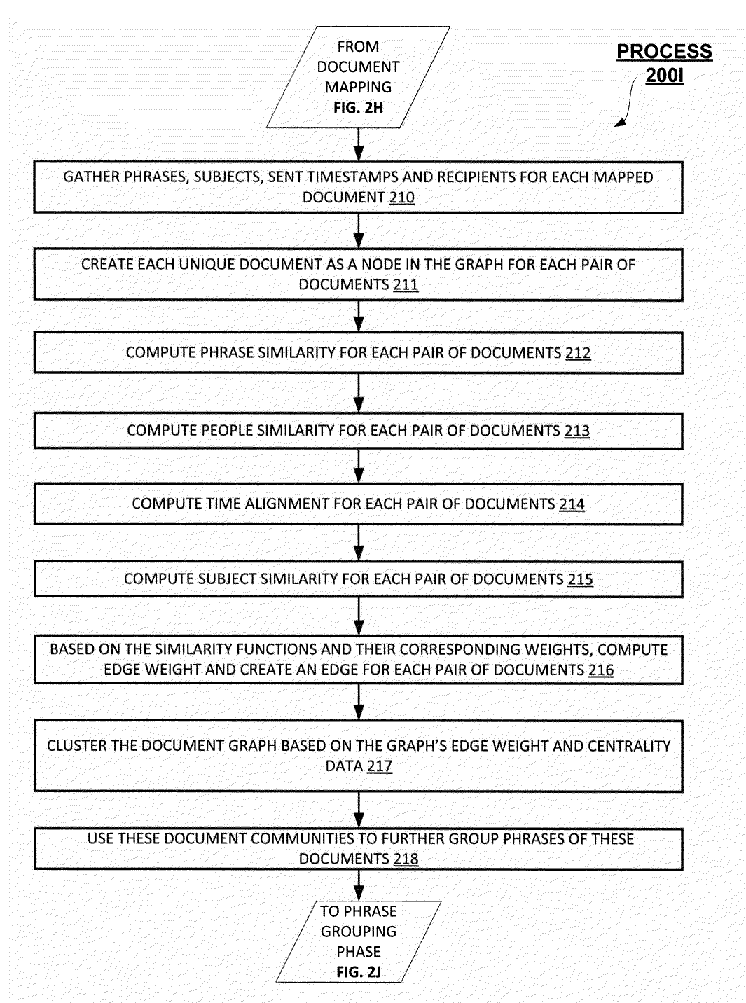

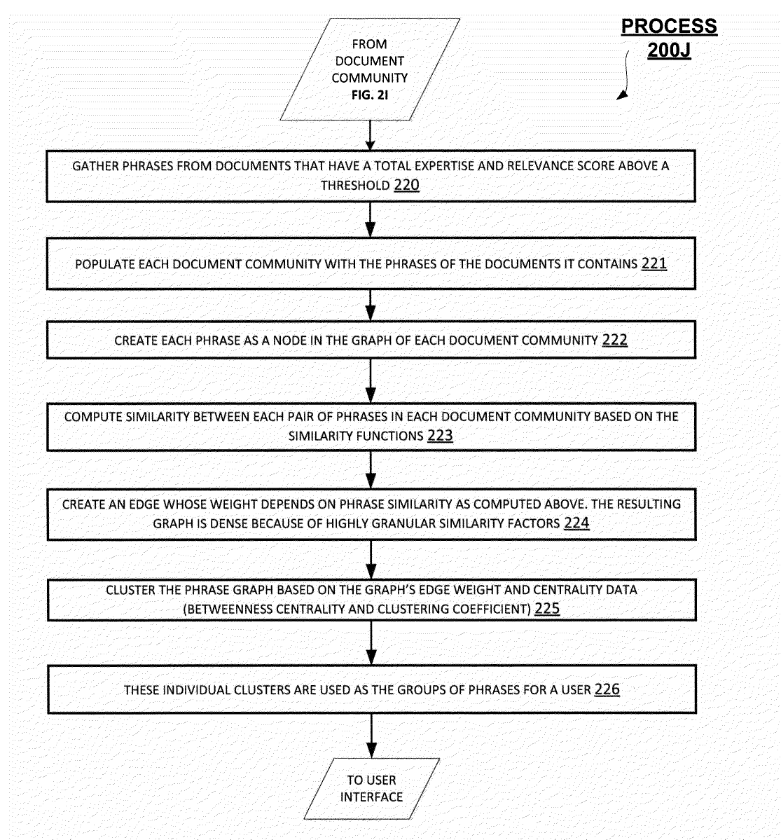

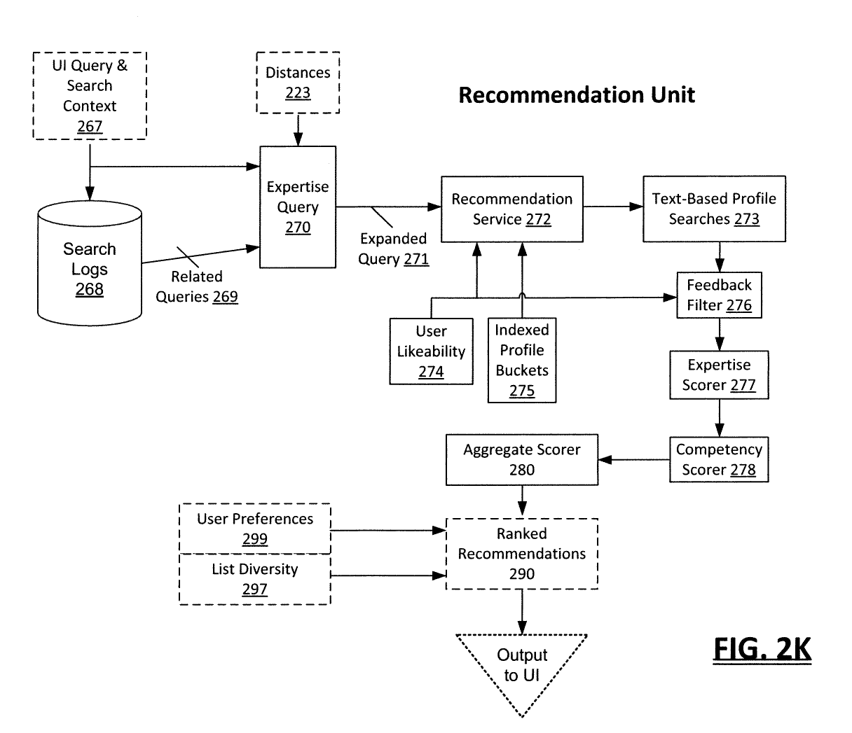

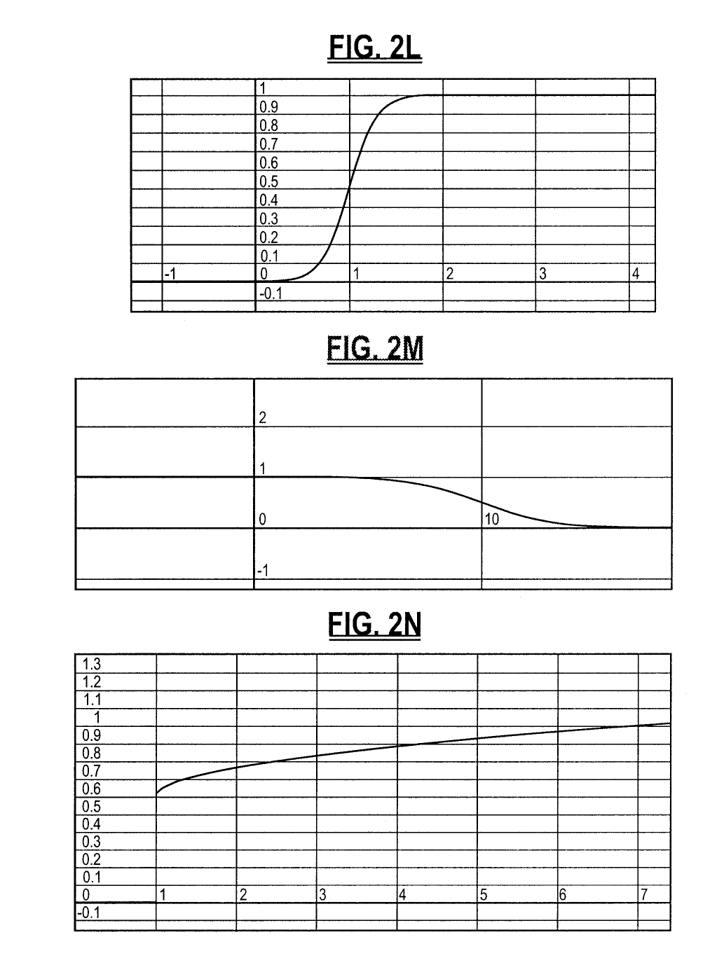

The linguistic processing pipeline according to the preferred embodiment includes several functions that can be performed on user data to assist in identifying and indexing relevant keywords and concepts, grouped in terms of context, for building highly relevant and accessible complete and partial user profiles. FIG. 2A depicts an illustrative embodiment of a linguistic processing pipeline. This embodiment of linguistic processing pipeline shows how a user's data is parsed for building user profiles. In the illustrated embodiment, the users' data includes document(s) 209 along with their components and metadata. FIG. 2A illustrates such components and metadata using email communication(s) 201. In one embodiment, document(s) 209 may be atomic or composite. Other user data such as chats, text messages, etc. can be parsed as user data, and the techniques disclosed herein are not limited to any particular user data.

Email 201 is separated into its constituent parts. The metadata is used to identify the persons the user is communicating with in the To, cc, and bcc fields, as well as the domain(s) and dates associated with the email communication. The sentences within the body of the email and the email's subject field, are input to unit 203 for linguistic parsing. Salutations and sign-offs are broken down into n-grams 208 and input into global statistical processing (terms) 212 for filtering and extraction of proper names using statistical analysis. As used herein an n-gram is defined as a set of n consecutive tokens, where n is typically in the range 1 . . . 5. The linguistic parsing component 203 takes the sentences input from the subject and body of the email and outputs a list of noun phrases that indicate either a competency or a context (204). The processing performed by linguistic parsing component 203 is further described in the discussion of FIG. 2B below.

The list of noun phrases indicating competency or context 204 is then input into a competency detection unit 205 along with a set of verb phrases 232 extracted in linguistic parsing unit 203 to generate a list of text annotations 207 and a set of corresponding tags 206 that are used to assist in concept scoring and promotion. The list of noun phrases 204 is annotated based on competency or context level. The resulting text annotations 207 are pooled together with other global concepts 210 to be input into scoring component 214 for concept scoring. Text annotations 207 are also input into unit 211 for local statistics processing (discussed further below in FIG. 2D). The local statistics processing performed on text annotations 207 is for statistically characterizing the usage of a concept by a single user.

In at least certain embodiments, the global statistics processing that was performed on the n-grams 208 and pooled text annotations 207 discussed above statistically characterizes the usage of noun phrases, single words (even within phrases), names, and name variants by all of the users within an organization or a group. There are three outputs of the global statistical processing unit 212 including the global list of mentioned concepts 210, recognizable and recurring names and name variations 217, and list of stemmed concepts 293 that is output to the promotion service 213. The global concepts 210 are pooled together from the text annotations 207 concepts by combining the data of all text annotations 233 that have the same presentation value 235 as shown in FIG. 2B. Global concepts 210 are made available to scoring component 214 for determining probability scoring into expertise keywords or a particular context for each concept. The context can be anything, but in the preferred embodiment includes the names of particular projects, products, or customers that the user is associated with in order to match the user's competencies to those contexts for easy identification in search results for persons with a relevant competency or experience. Whereas FIG. 2E further describes the details of scoring component 214, suffices it to note that the detection of recognizable names of products, projects, and customers is performed by the named-entity scorer 258. Other context identifiers, including, but not limited to, the names of key individuals, teams, groups, locations, initiatives, deals, events, or other named entities, are equally well recognized by the named-entity scorer 258.

Concepts are scored based on the probability they are associated with an expertise keyword or a project, product, or customer context. The process of scoring that takes place in scoring component 214 is described further below in the discussion of FIG. 2E. The probability a keyword indicates an expertise or competency, shown as Pr{expertise keyword} in the figure, is output from the scoring component 214 to promotion service 213 where an algorithm is performed to promote or not promote a particular keyword for indexing in a user's profile. In the illustrated embodiment, promoted concepts 221 are output from promotion service 213 to clustering service 222. Clustering service 222 also receives as inputs distances 223 between concepts 293 that are computed using distance functions 224 and proximity measures 226 output from graph processing unit 225, which is described in more detail below in FIG. 2G.

The probability that a concept is associated with a particular context (e.g., project, product, customer), shown as Pr{project context} in the figure, is also output from the scoring component 214 and input to unit 218 to receive a suggested label. Users also may assign their own labels 219 at this point in the pipeline. The labeled concepts from unit 218 are then combined with the outputs from the clustering service 222 and organized into profile buckets 220 based on context, and output to the user interface (UI) of the system. These are organized in terms of context to facilitate knowledge management, to facilitate a knowledge base, and to enable finding relevant persons through competence-based or context-based search queries.

FIG. 2B depicts an illustrative embodiment of a linguistic parsing component. The linguistic parsing component 203 takes as input sentences from a user's data including a user's documents, components and metadata, including, but not limited to, email message documents 209 and email metadata and message components 201 shown in FIG. 2A. These sentences are then parsed using various methods and output as a list of noun phrases that indicate a competence or a particular context. In the illustrated embodiment, the sentences are tokenized into sentence tokens 227 and are input into kill mail unit 228. Kill mail unit 228 filters out unwanted or highly-private email communications that are either not relevant to an expertise or competency of any kind, or are not relevant to a desired context such as projects, products, and customers. Kill mail 228 takes as inputs salutations and sign-off patters rules 229 and number of dictionary matches rules 230 that are used in determining whether or not to kill a particular email communication or document. For illustration purposes only, the Kill mail 228 may classify as irrelevant emails that contain terms of confidential business deals. It may realize this behavior by removing, for instance, any message containing 5 or more terms from a dictionary of merger and acquisition related terms. The Kill mail unit 228 may also use a classifier of much greater sophistication, such as a trainable pattern classifier or a Bayesian decision rule, in order to make such determinations.

Relevant sentences then receive part of speech tags 231, from which verb phrases 232 are extracted. The part of speech tags are also used by a noun phrase chunker that generates noun phrase chunks 233 which are then output to drop from end handler 234 where further parsing is performed by dropping common end words in phrases. Noun phrases are conventionally viewed as head words whose meaning has optionally been extended or restricted by certain modifiers. Generic head words such as ‘item’ or ‘notes’ may be removed from the end without altering the meaning or import of the noun phrase. Likewise, certain generic determiners such as ‘the’ and ‘another’ may also be removed. All noisy special characters and unwanted words from phrases should be filtered out in this part of the pipeline in order to output presentation values 235 that are free from noise. Drop phrase rules 236 are then applied to the output noun phrase chunks presentation values 235 as a list of noun phrases indicating competency or context 204. Drop phrase rules 236 may perform a variety of checks on the presentation value of the phrases, including, but not limited to, the following: removal of generic single word phrases such as “meeting”; removal of common business communication terms such as “PDF attachment”; or removal of phrases containing taboo words indicating depravity or humor.

Competency detection unit 205 receives the list of noun phrases 204 and extracted verb phrases 232 from the linguistic parsing unit 203, and outputs a set of tags 206 that are output to scoring unit 214 used to assist in concept scoring and promotion. FIG. 2C depicts an illustrative embodiment of a competency detection unit. In this embodiment, competency detection unit 205 performs semantic expansion by level function 237 on a given list of competency indicating terms 298. It is configured to annotate each phrase from the input list of noun phrases 204 with tags describing any matches against the expanded list of competency indicating terms that occur within the words surrounding that noun phrases.

Semantic expansion by level functions 237 recognize not merely what noun phrases are mentioned by a user, but with what competency they are associated. Competency level annotation process 238 is then performed on the list of expanded noun phrases and on the extracted verb phrases 232 input from linguistic parser 203. The competency level annotation process 238 generates tags 206 for text annotations that can be used later in the pipeline for concept promotion and scoring. By way of illustration, FIG. 2C depicts the set of surrounding verb phrases 232 being used for this purpose. For instance, if the competency term “cut” (a verb) indicating competency level 2 was present in the list 298, then semantic expansion 237 can expand it to similar terms “cut,” “slice,” “dice,” or “shred” for example. And if the incoming verb phrase 232 was “dice cucumber” and the incoming noun phrase in list 204 was the word “cucumber,” its corresponding annotation 238 derived from verb phrase 232 will receive a tag 206 indicating its competency level as level 2.

### Statistical Filtering and Scoring of Concepts

The text annotations 207 and documents 209 are input to local statistical processing unit 211 of the statistical processing pipeline 200 D, one embodiment of which is shown in FIG. 2D. Local statistics processing unit 211 can perform both local statistics common filtering 239 and local statistics rare filtering 241 on these inputs 207 and 209. Terms that are used rarely by the user are either dropped or filtered out by rare filtering 241. For instance, terms that occur in only one document or terms that are mentioned by the user fewer than twice may be dropped. Next, local statistics common filtering 239 may drop terms mentioned too frequently by the user. For instance, terms that are used more than twice (on average) in all documents may be flagged for negative scoring.

The usage of phrases may be characterized in further detail. For instance, the output of the local statistics common filtering 239 includes the frequency by phrase word count 240, which counts separately the usage of phrases of different lengths, where phrase length is the number of words in a phrase. Since a single-word phrase such as “idea” is likely to be used more often than a longer phrase such as “brilliant idea,” the frequency of occurrence of each kind of phrase is tracked separately for each user. Rules that indicate rare, excessive, or competency-indicating usage then flag the phrase for greater or lower probability of promotion in frequency by phrase word count unit 240.

All statistical data from Local Statistics (shown in FIG. 2D) and Global Statistics (not shown for brevity) is input into the epoch engine 243 along with user concept annotations 242. Epoch engine 243 functions as a time machine, making available statistics from different periods and durations. Epoch engine 243 is timed by a clock reading received as input from clock 244. Epoch engine 243 further receives various configuration rules 245, which may be system or user-defined rules. Epoch engine 243 is responsible for taking and maintaining snapshots of the statistics database at different times. The rules 245 govern how many snapshots are maintained, covering which specific periods and durations. For instance, 3 snapshots describing statistics covering annotation from documents spanning a one-week duration may be kept from the beginning of one-month periods.

Concepts 210 and n-grams 208 are input to global statistical processing unit 212 of the statistical processing pipeline 200D shown in the illustrated embodiment. Global statistics processing performs both global statistics common filtering 248 and global statistics rare filtering 249. Single word statistics 250 are computed. Name extraction 251 is performed on n-grams 208. Relevant names and name variations are detected and extracted and stored in database 252. The names and name variations 217 stored in database 252 are used as inputs to the scoring algorithms of the scoring unit 214. Concepts that match names or name variants are either removed or flagged for lower scores during promotion scoring 213.

In the preferred embodiment, the global statistics processing scorer 212 reports the score of a phrase in the range from zero to one [0, 1] based on statistics of usage of the phrase within the global scale (i.e. in whole company or community). The main intent is to estimate a confidence of the given phrase to be not too common and not too rare. The global statistics scorer function is a continuous function having a “hat” behavior—i.e., close to zero on values near zero and after some other positive value. In this embodiment, the global statistics scorer function consists of two parts: (1) rare function (fr); and (2) common function (fc). Rare function fr assigns a score based on how rarely the phrase is used in the community, while common function fc assigns a score based on how commonly the phrase is used in the community, i.e. the fraction of people using it frequently enough. The rare function can be a sigmoid function based on frequency of a phrase in community communication. For instance, the global statistics scorer can be defined as:

f(F, C, K, x)=min(fr(F, x), fc(C, K, x))

, where F, C, and K are input parameters:

F is a threshold frequency

c(x)—global frequency of a phrase; and

$$fr ( F , x ) = \frac{1}{1 + {e}^{p ( F - c ( x ) )}} ,$$

and where

$$\frac{ρ = {log}_{ɛ} 10000}{F}$$

is the normalization parameter.
The default value of F is 1. FIG. 2D shows the resulting graph.

The common function can also be a sigmoid function based on percentage of users that use particular phrase not less than some amount of times.

C—is a threshold frequency of a phrase in a user's profile

u(C, x)—number of users that use phrase “x” at least C times.

U—total number of users.

, where K is a threshold value that identifies the percentage of users that used phrase X at least C time:

$$fc ( C , K , x ) = \frac{1}{1 + {e}^{p ( \frac{u ( C , x )}{U} - K )}} ,$$

and where

$$\frac{ρ = {log}_{ɛ} 10000}{F}$$

is the normalization parameter.
The default value of K is 10, and the default value of C is 4. FIG. 2M shows the resulting graph.

### Competency Scoring

Additional competency scoring can also be used in the preferred embodiment. In such an embodiment, an additional scorer reports the score of a phrase in the range of [0,1] based on the linguistic property of the phrase. This is used to identify the “skill level” of a phrase and its values may vary between zero (0) and seven (7), where 0 represents no skill level at all or the inability to identify the skill level, and 7 represents highest skill. The additional scorer function in this embodiment is a slow-growing discrete function that reaches its maximum value of one (1) at the maximum level and has a significant jump for strictly positive skill level values.

P—the minimum score that phrases receive.

M—maximum level.

p(x)—level of the phrase x.

$$f ( P , M , x ) = \{ \begin{matrix}0 , & p ( x ) = 0 \\ P + ( 1 - P ) \sqrt{\frac{p ( x )}{M}} , & p ( x ) > 0\end{matrix}$$

This function reflects the assumption that once the level is larger than zero, the score for it should not be significantly distant from the score of other levels. The default value for P is 0.6 and the default value for M is 7. FIG. 2N shows the resulting graph.

FIG. 2E depicts an illustrative embodiment of a scoring component. In this embodiment, name filtering 255 and named-entity filtering 256 are applied on the name and name variations 217 and on the global concepts 221 input to the scoring component 214. Name filtering removes concepts that match a complete first and last name detected by name extraction 251 of FIG. 2D. Named entity filtering removes annoying concepts such as airport codes and common locations. The output of this filtering is placed on scoring bus 260 as shown. In addition, competency scoring 257 and named-entity scoring 258 are performed on concepts 221 and also output onto scoring bus 260. In the illustrated embodiment, scoring bus 260 is coupled with an aggregate scorer unit 261 for the purpose of scoring all concept keywords in the aggregate to determine the probability that a concept keyword indicates an expertise or competency, shown as Pr{expertise keyword} in FIG. 2E, or to determine the probability that a name keyword indicates a particular project, product, or customer context, shown as Pr{project context} in the figure. The context probabilities, Pr{project context}, are then labeled by system 218 and user assigned labels 219, and organized into profile buckets 220.

The preferred embodiment of the scoring functions uses graded scoring with conditional probabilities directly and in the aggregate.

### Named-Entity Scoring

The preferred embodiment of the named-entity scorer is a capital-case-based scorer. Consider a candidate concept “c” with presentation value “t” with evidence sets T₂, T₁ and T₀, respectively, corresponding to text annotations of that presentation value with CAP_CASE_VALUE=2, 1, or 0. In one embodiment, the value zero indicates lack of capitalization; the value 1 indicates capitalization at the beginning of a sentence or subject; and the value 2 indicates capitalization in the middle of a word or phrase. For example, the word “eBay” would get a value of 2 as it is highly-indicative of a named-entity since it has a capitalization in the middle of the word.

Further suppose the existence of a predicate “subject( )” that can be tested against a particular text annotation to determine whether the annotation is the word or phrase, and suppose the existence of a predicate “allcaps( )” that can be tested against a particular text annotation to determine whether there is no lowercase text present in the word or phrase, either immediately before or immediately after the phrase. Now suppose the existence of “pwc( )” a function that returns the word count of a phrase. The output is zero if it is certain that the word or phrase is not a proper noun or noun phrase, and the output is a +1 if it is certain that it is a proper noun or noun phrase. Negative outputs are not produced because the absence of proper-noun characterization is not a basis for leaving a term or phrase out of a user's profile. The presence of proper nouns, on the other hand, contributes in a positive way to membership in a profile. The goal of the formula is to support promotion into the profile only when strong evidence of true capitalization exists. We first examine the possible situations and then count the number of instances of each type, in reverse order of confidence.

### Evidence Structure of Named-Entity Scorer

| Case | Descriptions |
|---|---|
| nsc | The count of non-successive capitalizations within the word(s) of the |
| | phrase |
| sc | The count of successive capitalizations (not all caps) within the |
| | word(s) of the phrase |
| mcc | The count of middle-letter capitalizations |
| mfc | The count of first letter capitalizations in the words of a multi-word |
| | phrase |
| lpd | The count of special character words, and all-lowercase prepositions, |
| | determiners and coordinating conjunctions |
| ltw | The count of all-lowercase trailing words that are neither special |
| | character words, nor all-lowercase prepositions, determiners or |
| | coordinating conjunctions |
| llw | The count of all-lowercase leading words that are neither special |
| | character words, nor all-lowercase prepositions, determiners or |
| | coordinating conjunctions |
| acc | The count of all caps words insider a non-all-caps phrase |
| lwc | The count of all-lowercase words in a phrase containing all-caps |
| | words |
| cc2 | The count of CAP_CASE = 2 evidences |
| cc1 | The count of CAP_CASE = 1 evidences |
| cc0 | The count of CAP_CASE = 0 evidences |

A slight penalty for uncapitalized words that are either all-lowercase leading words, all-lowercase trailing words, or all-lowercase middle words that are neither propositions, determiners, coordinating conjunctions, nor special characters. This penalty function creates a bias toward recognizing with the highest score for the candidate concept from among a set of closely related candidate concepts mentioning the same named entity—the ones exhibiting the tightest maximally capitalized presentation value. Due to the structure of noun phrases containing named entities, there is a greater penalty given in the below equation for candidate concepts that contain leading all-lowercase words than for trailing ones:

puc(t):=0.1 min(llw(a))+0.05 min(ltw(a)),

where the minimization is performed over all the text annotations “a” of a candidate concept “t”. Thus, candidate concepts whose text annotations contain leading or trailing words around the capitalized words will be slightly out-of-favor compared to the ones that don't.

The scoring function of the preferred embodiment is a graded scoring function given by:

∃tin T₂∪T₁ with (nsc≧1)?pnscore:=1(e.g. TexOk) pnscore:=pnscore−puc( )

∃t in T₂∪T₁ with (sc≧1)?pnscore:=1(e.g. Enfolio II, MaxDQ) pnscore:=pnscore−puc( )

∃t in T₂∪T₁ with (mcc≧1)?pnscore:=1 e.g. eBay pnscore:=pnscore−puc( )

∃t in T₂∪T₁ with (mfc>0)?

Let f=0.5 [0.5 cc1/(cc1+cc0)]̂cc0 (0.5 when only cc1 evidence, 0.125 when one cc1 and one cc0 evidence, drops off very rapidly as cc0 evidence builds up):

| cc0 | cc1 | f |
|---|---|---|
| 0 | 1 | 0.5 |
| 0 | 2 | 0.5 |
| 1 | 0 | 0 |
| 1 | 1 | 0.125 |
| 1 | 2 | 0.166667 |
| 2 | 0 | 0 |
| 2 | 1 | 0.013889 |
| 2 | 2 | 0.03125 |

pnscore:=f+(1−f)max((mfc−1)/(pwc−lpd−1))

pnscore:=pnscore−puc( ), where the maximization is performed over all annotations a oft.

As an example, for the phrase “Federal Bureau of Investigations,” when there are no CAP_CASE=0 (“cc0”) instances, “Federal Bureau of Investigations” will get a score of 0.5+0.5*2/ (4−1−1)=1. But “Federal bureau of investigations” will get the score 0.5. If to this situation we add one cc0 annotation where “federal bureau of investigation” is listed in all lower case (and still no CAP_CASE 2 instances), the score will still be 1 (=0.125+0.875) for “Federal Bureau of Investigations,” but will drop to 0.125 (from 0.5) for “Federal bureau of investigations.”

Otherwise, either there is some T2 evidence or there is only T1 evidence, but a letter other than the first letter of the phrase is capitalized. There could also be all-lowercase leading words present.

pnscore:=2[1−2̂-[(cc2+cc1−min(cc0, cc2+cc1))/(cc2+cc1)]] max(mfc/(pwc−lpd))

pnscore:=pnscore−puc( ) where the maximization is performed over all annotations a of t.

The ratio on the right mfc/(pwc−lpd) captures the fraction of words that could have been capitalized but were not. The table below shows the weighting structure of the evidence-counterevidence multiple applied to the ratio. Notice that cc1 and cc2 evidence is treated the same here.

| cc0 | cc1 + cc2 | f |
|---|---|---|
| 0 | 1 | 1 |
| 1 | 1 | 0 |
| 0 | 2 | 1 |
| 1 | 2 | 0.585786 |
| 2 | 2 | 0 |
| 0 | 3 | 1 |
| 1 | 3 | 0.740079 |
| 2 | 3 | 0.412599 |
| 3 | 3 | 0 |
| 0 | 4 | 1 |
| 1 | 4 | 0.810793 |
| 2 | 4 | 0.585786 |
| 3 | 4 | 0.318207 |
| 4 | 4 | 0 |
| 0 | 10 | 1 |
| 1 | 10 | 0.928227 |
| 2 | 10 | 0.851302 |
| 3 | 10 | 0.768856 |
| 4 | 10 | 0.680492 |
| 5 | 10 | 0.585786 |
| 6 | 10 | 0.484283 |
| 7 | 10 | 0.375495 |
| 8 | 10 | 0.258899 |
| 9 | 10 | 0.133934 |
| 10 | 10 | 0 |

If multiple cap-case rules apply, the largest assigned value of pnscore is considered. Candidate concepts that remain unassigned by all rules get a pnscore of zero.

### Subject-Body Weight Scoring

The goal of the subject-body scoring feature is to boost the chances of promotion into profiles for those phrases that occur in certain eye-catching positions in users' documents. This feature takes into account the source of a phrase and tags and scores it accordingly at a conceptual level. For example, if the potential sources of keywords in an email body are represented as follows:

| Email Subject | | Calendar | |
|---|---|---|---|
| Line | Email Body | Subject Line | Calendar Body |
| es | eb | cs | cb |

, then the subject-body weight score can be computed using the following illustrative algorithm:

let f=frequency of phrase in user's local statistics,

let ss=computed subject-body weight score, and

let c be a concept under evaluation,

if f(c in eb)=0, then ss(c):=0;

else, ss(c):=min(1, (f(c in es)+f(c in cs))̂2/(f(c in eb)+f(c in es)+f(c in cs))),

where min( )is a function that returns the least-valued among its arguments.

### Phrase Pattern Scoring

In at least certain embodiments, the phrase pattern scorer reports the score for a phrase in the range of zero to one, where a value of zero indicates the likelihood of a phrase being a good phrase (e.g., proper noun, named entity, etc.) is very low, and a value of one means that there are very high chances that the phrase is a good phrase. This can be performed by considering various characteristics of a phrase such as the word count in the phrase, the average length of words in that phrase, conjunctions in the phrase, or conversion rate of a phrase, which can be computed as follows:

| | |
|---|---|
| One word phrase | 0.1 |
| Two word phrase | 0.3 |
| Three word phrase | 0.4 |
| Four word phrase | 0.3 |
| Five word phrase | 0.5 |

For all other situations, a default conversion rate of 0.05 is used. The scoring function can be driven by variance of a phrase's characteristic as compared to its distribution. In one embodiment, it uses the logistic regression formula which report only positive scores ranging from zero to one.

$$ScoringFn ( phrase ) = 1 - \frac{1}{1 + {e}^{- z}} where , \\ z = Default z Score - ConversionRate ( word count ) + \sum Abs ( a * z )$$

For single words phrases, the final score can be further down-weighted by multiplying the score by 0.2. A default “z” score is the standard score of a contributing quantity whose measured value is x, mean is μ, and standard deviation is σ. The contributing factors considered in an embodiment of the phrase pattern scoring function are the word length (average number of letters in each word) of a phrase and its word count.

### Promotion Scoring Function

Referring back to FIG. 2A, the expertise keyword probabilities, Pr {expertise keyword}, are input into the promotion service 213 where it is determined whether or not to promote the keyword as an expertise keyword based on the output of the scoring algorithms of scoring unit 214. Promotion algorithms are known in the art and any promotion algorithm may be used in accordance with the techniques described herein. In the preferred embodiment, the main formula for deriving a promotion score is given by the following table of calculations:

| | | |
|---|---|---|
| 0.2* [ | | Normalizing to 0 . . . 1 range overall |
| 0.75 * ( | | ¾ linguistic weighting of core score |
| 0.75 * | Competency score * usage_gating | Relative weighting of Competency |
| + 1.00 * | CapCase * usage_gating | |
| ) + 0.25 ] | | ¼ baseline weighting of core score |
| * [ | | Supplemental Boost of Core Score |
| 1 | | |
| + 0.25 * | usage_boosting | Even ordinary noun phrases (other than Competency and CapCase) are usage boosted |
| + 0.25 * | Phrase Pattern | Boost good-looking phrases |
| + 0.25 * | FbyD | Boost phrases with sweet spot of frequency |
| + 0.25 * | Subject-Body Weight | Boost phrases that are used in eye-catching positions in documents |
| − 0.50 * | LocalStats score | In addition to LocalStats filtering |
| − 0.50 * | Location score | Suspected but not filtered locations |
| − 0.50 * | Name scorer | |
| ] | | |
| * | Conjunction Filter * Containment Filter | Phrases containing special characters, “and”, “or”, “/”, “&” are given zero score. |
| | | Concepts in plural form whose singular forms are also present separately in the profile |
| | | are given zero score. |

Calculation of usage gating is as follows.

| | | |
|---|---|---|
| 0.25 * | 1 | ¼ free pass for ordinary usage |
| + 0.75 * | | ¾ weighting of good usage |
| MAX ( | | meaning |
| 1.0 * | SubjBodyWt (range: 0 . . . 1) | Used in subj & body |
| 8.0 * | FbyWC (range: −0.125 . . . 0.25) | Above avg freq for its phrase |
| | | length |
| ) | | |

Calculation of usage boost is 0.25 + 0.75 * usage gating

The concepts that are good enough to be promoted are output as promoted concepts 221 from promotion service 213. The promoted concepts 221 are then input into clustering service 222 as shown in FIG. 2A.

The output of graph processing unit 225 of FIG. 2A is also input into the clustering service 222. FIG. 2F depicts an illustrative embodiment of a graph processing unit. In this embodiment, graph processing unit includes a user community detection component that receives as input the following data fields as shown: (1) people similarity; (2) shared concepts; (3); shared topics; (4) temporal alignment; (5) and semantics. These are also input into the document mapper 263 along with the user's documents 209. A document communities unit 264 is used that receives promotion scores 265 as input. The distances calculated between all the words in a particular context or community are determined by distance algorithms which are known in the art. The results of the distance algorithms determine a relative distance between persons and concepts. These distances are output to clustering service 222. Based on the calculated distances, graph processing unit 225 determines and outputs the top words of a particular community 266. This output 266 in FIG. 2F is received by the structural proximity distance function 226 of FIG. 2A, which uses it to cluster together those concepts that belong to the same community, along with other considerations as represented by the outputs 223 of other distance functions 224. The profile search engine 44 shown in FIG. 1B uses these buckets of related concepts produced by clustering service 222 to serve up matching profiles in response to user interactions. It can perform this function using a recommendation unit described below.

FIG. 2G depicts an illustrative embodiment of a process of generating user communities. In the illustrated embodiment, process 200G begins by gathering documents (e.g., emails and meetings) that have been sent to the user (operation 201). Process 200G continues by gathering recipients and sender information from these documents (operation 202). In one embodiment, a node for this particular user whose profile is being organized is not created. Process 200G continues with operation 203 where a unique user (e.g., email address) is created as a node in a mixed graph (containing a mix of directed and undirected edges). Process 200G continues by creating an edge between a user and another user if both appear in the same document (operation 204). If both users are the recipient of the same document, then the edge weight, in one embodiment, will be assigned a value of 0.2 and undirected. The edge will be directed when either one of the users is a sender of that document and in that case the edge will point toward the recipients of that document, and in one embodiment, be assigned a weight value of 1.0.

Process 200G continues with operation 205 where the user's graph is clustered based on the graph's edge weight data and centrality measures (e.g., betweeness centrality and clustering coefficient). The individual clusters generated by this illustrative process will serve as a baseline for further mapping of documents in these communities, and at operation 206, individual clusters are output as one user community to the document mapping process. This completes process 200G according to an example embodiment.

FIG. 2H depicts an illustrative embodiment of document mapping. Process 200H begins at operation 207 by extracting documents sent by the user along with their recipient and sender information. Process 200G continues at operation 208 where the similarity of each document with each user community is computed. In one embodiment, the similarity is calculated as:

similarity:=(A∩B)/(AUB), where

A=set of recipients of the document; and
B=set of recipients of the user community.

Process 200H continues with mapping the document into the user community with maximum similarity (operation 209). This completes process 200H according to an example embodiment.

FIG. 21 depicts an illustrative embodiment of a process for creating a document community. Process 200I begins at operation 210 with gathering phrases, subjects, sent timestamps, and recipients for each mapped document. Process 200I continues at operation 211 where each unique document is created as a node in the graph and each pair of related documents is subsequently created as a weighted edge in the graph as follows. Process 200I then computes phrase-based similarity for each pair of documents at operation 212, and at operation 213, the similarity between documents based on mentions of people is computed for each pair of documents. In one embodiment, the phrase similarity and people similarity are computed using the maximum value of the two functions which are given by (A∩B)/A and (A∩B)/B. The time alignment similarity for each pair of documents is then computed at operation 214. In one embodiment, the time alignment is computed based on the time difference of the sent times of these two documents: the greater the time difference, the lesser the similarity. The subject matter similarity between each pair of documents is then computed (operation 215). In one embodiment, the subject similarity is a Boolean function which returns a value of one if the subject matches exactly and a value of zero if it does not. Then, based on these similarity functions and their corresponding weights, edge weight is computed and an edge is created for each pair of documents (operation 216). Finally, these document communities are used in order to further group the phrases of these documents (operation 218) which is further described below. This completes process 200I according to an example embodiment. This completes process 200I according to an example embodiment.

FIG. 2J depicts an illustrative embodiment of a process for phrase grouping. Process 200J begins at operation 220 where phrases are gathered from documents that have a total expertise and relevance score above a threshold 220. Process 200J continues with operation 221 by associating with each document community the phrases of that community's documents. Each phrase is then created as a node in a new graph, one per document community, at operation 222. At operation 223, the similarity is computed between each pair of phrases in each document community based on the similarity functions (alternatively, distance functions 224 in FIG. 2A). Embodiments include such similarity functions as co-occurrence in documents, textual similarity (e.g., shared words between phrases), semantic similarity (shared word senses or shared meanings according to a thesaurus, for instance), and similarity of surrounding phrases (also known as distributional or latent similarity). An edge is then created for each pair of related phrases whose weight depends on the phrase similarity computed above (operation 224). The resulting graph may be dense because of the highly-granular similarity factors. At operation 225, the phrase graph is clustered based on the graph's edge weight and based on the centrality measures associated with its nodes and/or edges. In one embodiment, this is based on the betweeness centrality and a clustering coefficient associated with each node (phrase). Finally, these individual clusters are used as groups of phrases and sent out to the user interface (operation 226). This completes process 200J according to an example embodiment.

FIG. 2K depicts an illustrative embodiment of a recommendation unit. In the illustrated embodiment, the recommendation unit uses search logs 268 in conjunction with user interface queries and search context 267 from users. These search logs 268 are used to find queries 269 related to user queries and search strings 267. These are combined into an expertise query 270 using relatedness measurements from the distances 223, such as structural distances produced by the graph processing unit 225. The resulting expanded query 271 is then input into the recommendation service 272. Recommendation service 272 also receives as inputs determinations of user likeability 274 (e.g., feedback about helpfulness and responsiveness) and the indexed profile buckets 275. Indexed profile buckets 275 contain concepts and their competency depth for each profile. Based on these inputs, recommendation service determines a text-based profile search 273 that is input to a feedback filter 276 based also on the user's likeability 274 input.

Profiles from the search results 273 receiving negative feedback in feedback filter 276 are either dropped or marked for low rank. This filtered text-based profile search is then scored for its expertise and its competency in expertise scorer 277 and competency scorer 278, respectively. The scored outputs are then aggregated together in aggregate scorer 280, and then a list of ranked recommendations 290 can be provided based on the search query, as well as user preferences 299 and list diversity 297 inputs. The list diversity 297 inputs set goals for location-based and function-based matches, as well as other considerations about what mix of results to show in response to profile searches. Likewise, user preferences 299 can occur in the form of favorites and hidden profiles. These considerations are taken into account when ranking the scored outputs for final display to the user in the user interface.

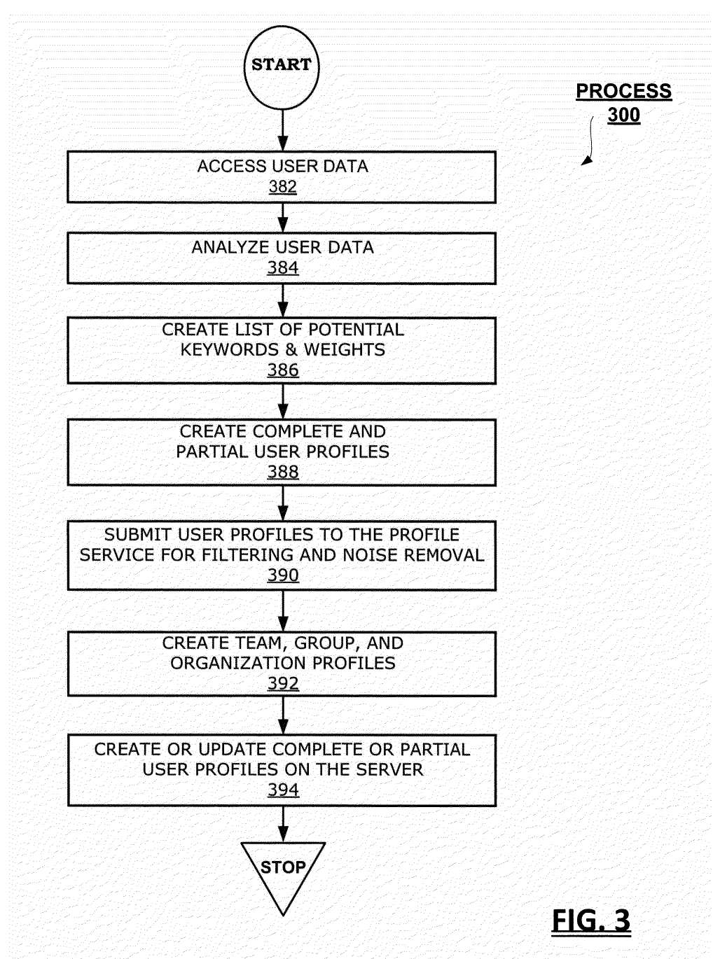

FIGS. 3-5 depicts exemplary flow diagrams of a method for implementing various embodiments. In discussing FIGS. 3-5, reference may be made to the diagrams of FIGS. 1A-1B to provide contextual examples. The various implementations disclosed herein, however, are not limited to those examples. FIG. 3 depicts the operations taken by client application 76 (FIG. 1B) to submit profile information to application server 12. Process 300 begins at operation 382 where, upon request of application monitoring service 58, periodic scan by tracking service 40, or user request or first time use by a user, client application 76 accesses user data 78, which is subsequently analyzed at operation 384. Then, at operation 386 the concept mining and analytic service 56 of client application 76 processes the data and creates keywords, including broad, functional, or narrow keywords, along with assigning their associated weights. The profile generator service 54 uses these keywords to create complete or partial user profiles (operation 388). These complete or partial profiles are submitted to the profile service 48 of application server 12 (operation 390). Profile service 48 may then forward the generated profile to data analytic service 38 configured to remove any noise from the user profile. This operation considers various attributes and removes unwanted or common profile keywords from the profile. It does this by referring to other user profiles, team profiles, or organization or community profiles. This information may also optionally be used by team builder 42 to improve or build teams, groups, or organization profiles (operation 392). The profiles are then created or updated (if already existing) in the profile database 36 at the server 12 (operation 394). This completes process 300 according to an example embodiment.

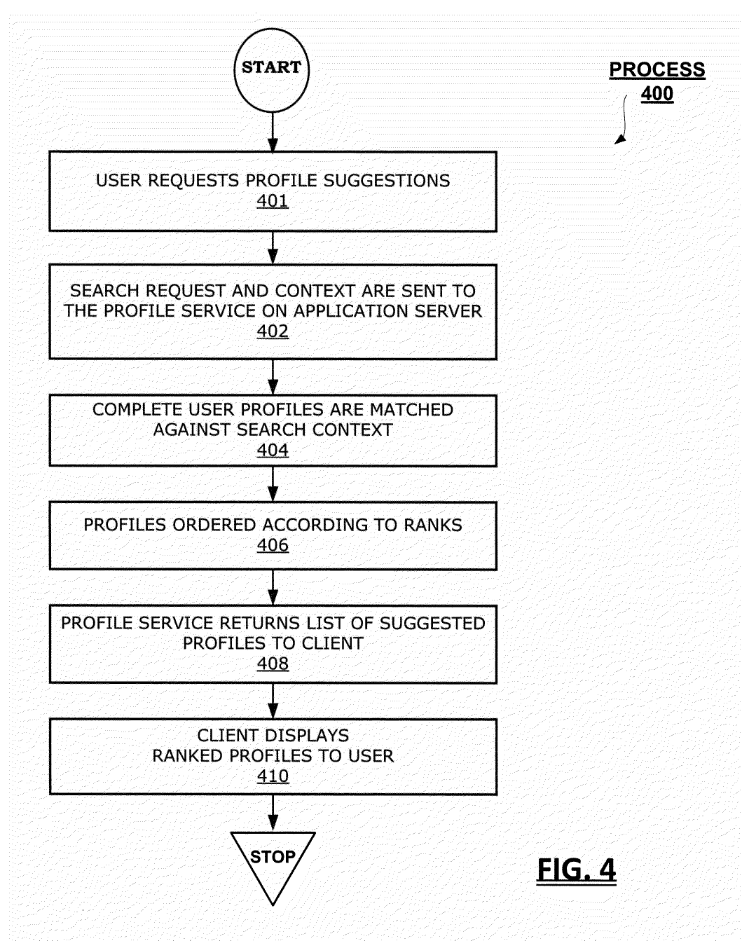

FIG. 4 depicts a process for searching user profiles according to an illustrative embodiment. In this embodiment, process 400 begins when a user requests profile suggestions and provides a search context to the system (operation 401). The search context may consist of one or more keywords or phrases. The request is sent from profile service interface 52 of client application 76 to the profile service 48 of server 12 (operation 402). The request is forwarded to the profile search engine 44 configured to perform the search based on the keywords and their associated weights. These keywords and search context are matched against the profiles of that organization or community (operation 404). The search is conducted based on one or more of the knowledge, communication, or connection aspect of the profiles. The profiles are then ordered based on their profile scores (operation 406) and the search results are returned by the profile service 48 to the client application 76 (operation 408) where they are displayed to the user in ranked order (operation 410). This completes process 400 according to an example embodiment.

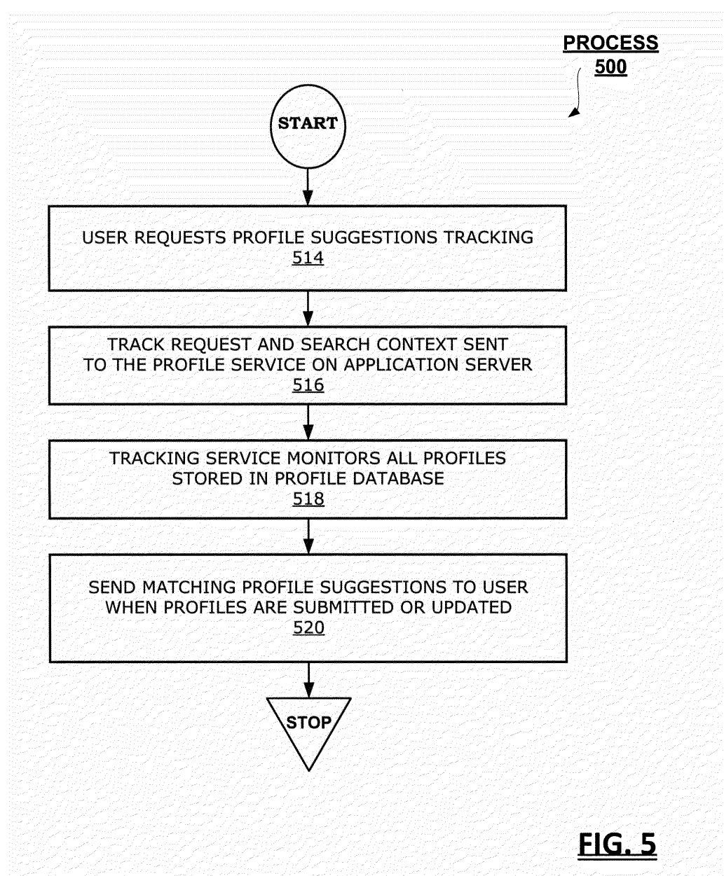

FIG. 5 depicts a process of profile tracking according to an illustrative embodiment. Process 500 begins when a user requests profile suggestions tracking and provides a search context (operation 514). This enables the user to be notified when a profile matches specific keywords within that context. These profiles are known as tracked profiles. The request is sent using the profile service interface 52 to the profile service 48 on application server 12 (operation 516). Following this operation, the request is forwarded to the tracking service 40 on server 12 (operation 518). The tracking service 40 is configured to monitor profiles that are being added or updated and to identify profiles matching the search context (operation 518). Since new profiles are continuously added to the system and existing profiles are updated on the system, tracking service 40 is used to assist in notifying the user when any profile matches the search context (operation 520). This completes process 500 according to an example embodiment.

Once a profile is created, the system generates and sends an invitation to the associated individual via electronic communication. The individual can then accept the invitation, which downloads and installs the client application 76 on the individual's device. This starts the tracking service and begins a preliminary scan of the individual's data. The client application 76 then submits updated profile information of the newly-enrolled individual to the application server 12. Additionally, client application 76 can upload profile data to both tracked profiles and un-tracked profiles, creating new partial profiles and enhancing existing profiles—both partial and complete. The transparency of partial and complete profiles and their associated metadata to entities outside the organization's network is governed at both the individual level and the organizational level. While individuals can adjust the privacy settings (e.g., the individual's ability to be found in searches) of their complete profiles both within and outside the organization or community, that individual's settings can be overridden by administrators of the organization or community. The designated administrators for the organization or community can also set up privacy settings for partial profiles for individuals outside the organization or community.

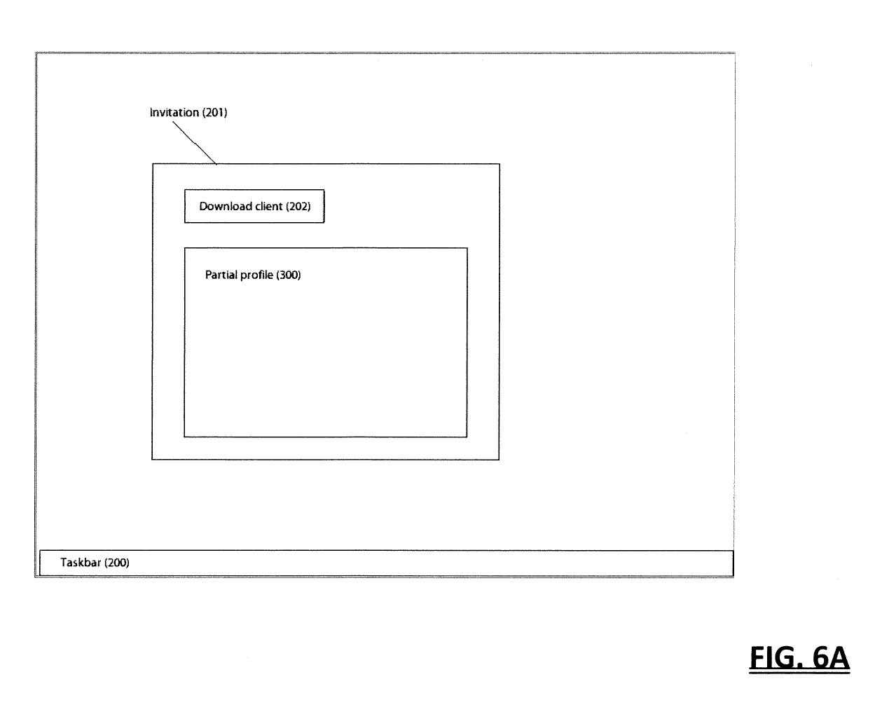

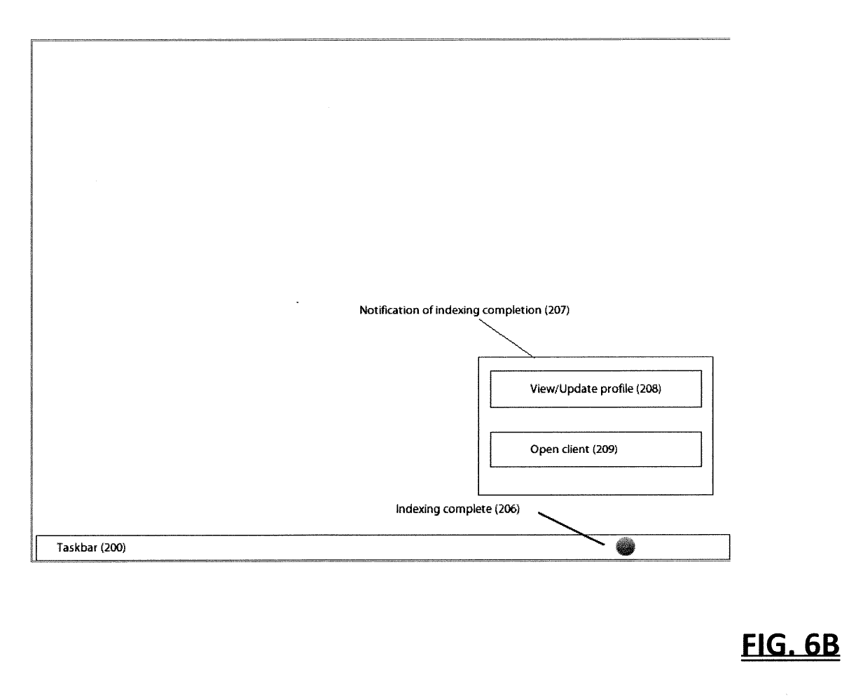

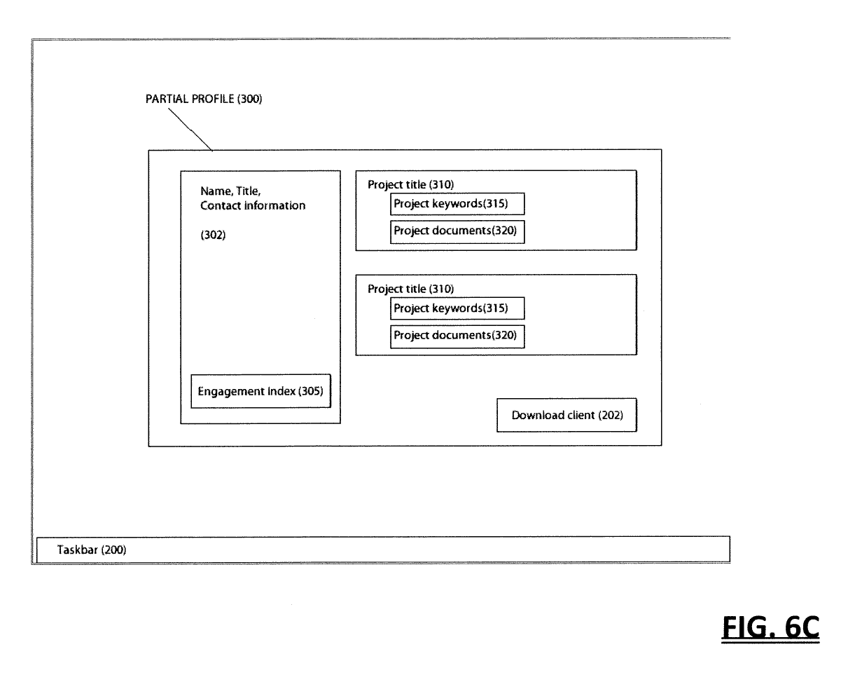

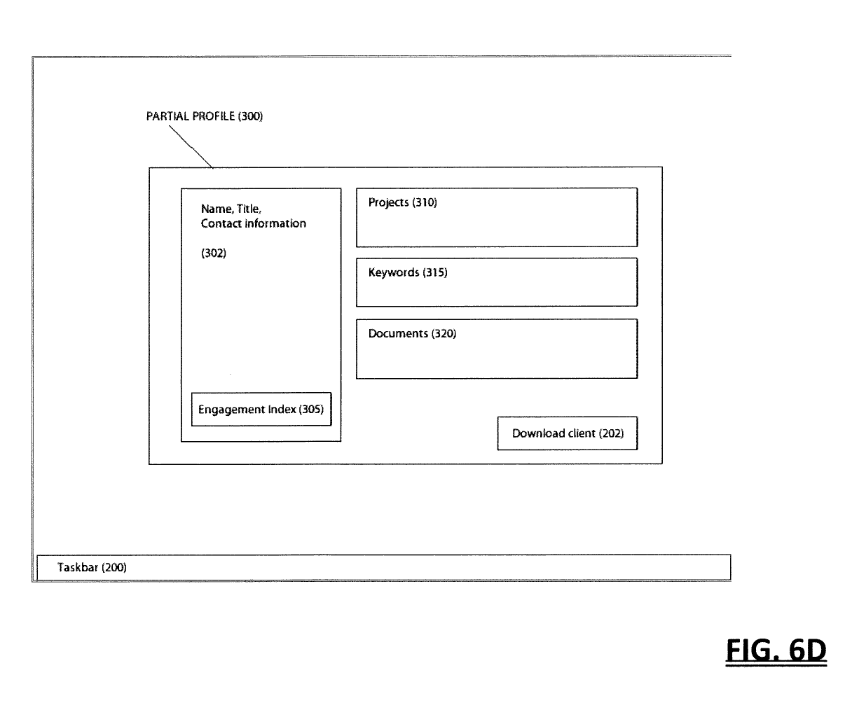

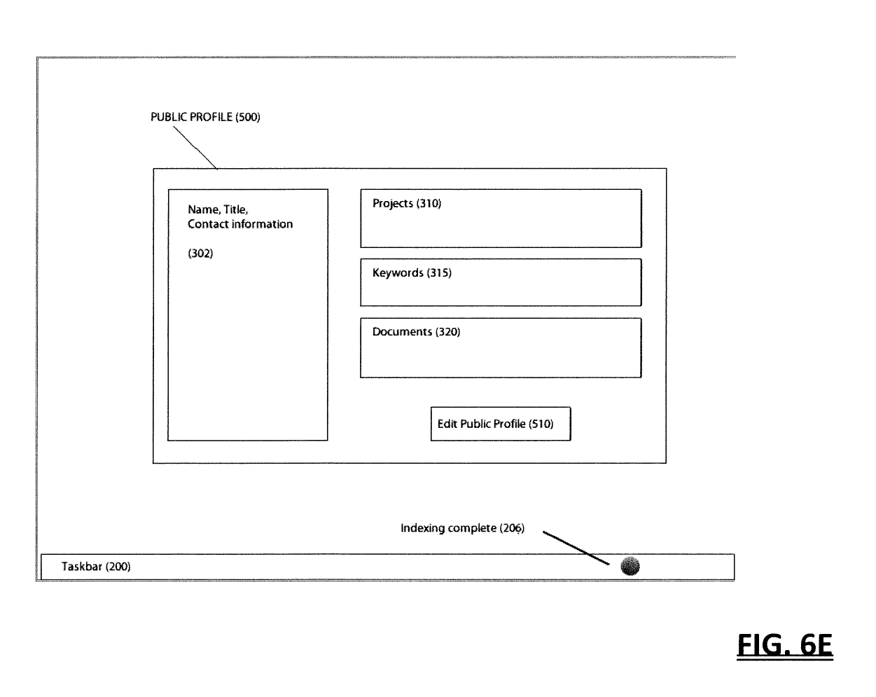

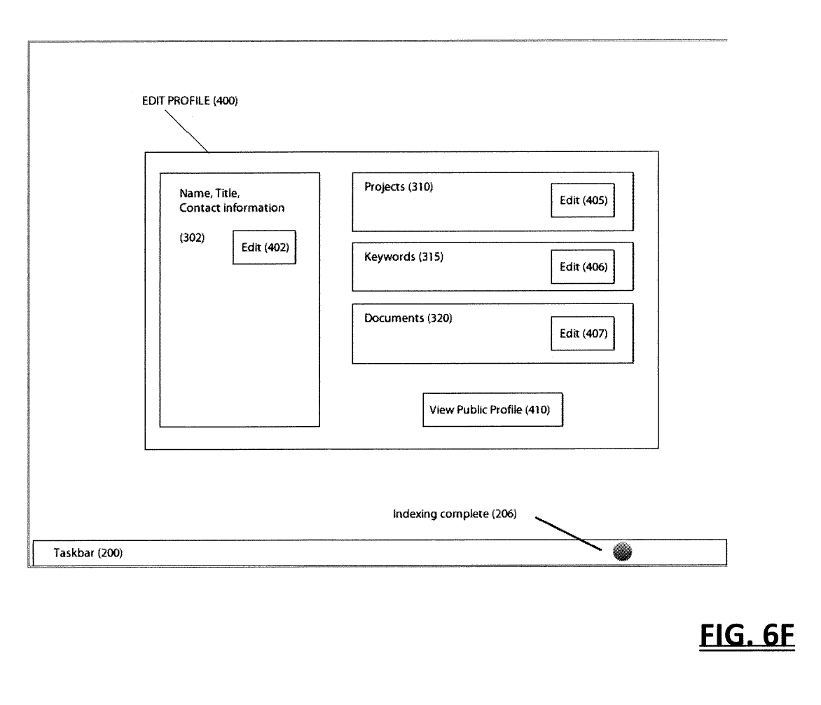

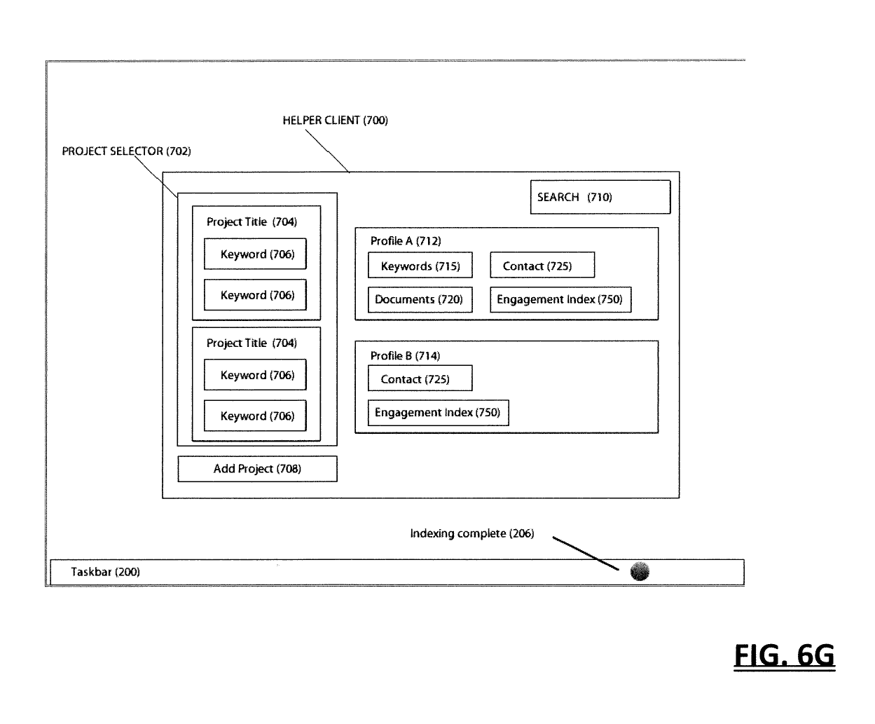

FIGS. 6A-6G depict exemplary graphical user interfaces according to various illustrative embodiments. FIG. 6A illustrates a representation of an invitation application in a graphical user interface. Such an invitation offers a potential user the option to download and install the client 202 or partial profile 300 for those individuals who are not current users of the system described herein. If the individual chooses to download the client, client 202 starts indexing his or her data and communications as described above.

FIG. 6B depicts an exemplary graphical user interface that includes an indicator 206 in a task bar 200 that indicates to the user that his or her data is currently being indexed. In at least one embodiment, when the indicator 206 is yellow, it indicates to the user that his or her data is currently being indexed, and when it is green, it indicates completion of the indexing process. An indexing completion notification 207 may also be included in the graphical user interface that allows the user to view and update his or her profile 208, or alternatively, to launch (open) the client 209.

FIG. 6C depicts an exemplary graphical user interface for displaying a partial profile 300 sent to a potential user according to one illustrative embodiment. As discussed above, the distinction between a full and partial profile depends on whether or not the individual is a user of the system. Individuals who have previously installed the client have full profiles once the indexing of their data is completed. FIG. 6C includes a system-identified name, title, and contact information 302, engagement index 305, project titles 310, project keywords 315, project documents 320, and a selectable download client 202. System-identified name, title, and contact information 302 are shown alongside an engagement index 305 associated with a user. Engagement Index 305 signifies the probability the user will respond to a request for contact. In one embodiment, engagement Index 305 varies for each user based on a variety of factors including: work load; relevance score; previous responsiveness to organization or community; or previous responsiveness to particular users. In the illustrated embodiment, keywords 315 and documents 320 are organized by projects title 310. But these fields can be organized in different arrangements as discussed below. When a partial profile 300 is shown outside the context of invitation 201 sent to a potential user (such as in search results), the download client option (202) may not be displayed. FIG. 6D depicts an exemplary graphical user interface for displaying a partial profile 300, but organized in a different arrangement. In this embodiment, keywords 315, documents 320, and projects 310 are organized in their respective groupings. FIG. 6E depicts an exemplary graphical user interface for displaying a public profile 500 according to one illustrative embodiment.

A user may view his or her own profile using the client. In at least certain embodiments, a user has two views available including a public profile view 500 (FIG. 6E) and an edit profile view 400 (FIG. 6F). These views can be toggled from the user's profile. In the embodiment illustrated in FIG. 6E, public profile 500 includes a representation of the individual's profile as it appears to others. This is very similar to a partial profile 300, except for the “edit public profile” option 510. If multiple levels of privacy exist (e.g., permissions based visibility), the user can toggle through each permission level. And, just like a partial profile 300, the contents of this screen can be displayed in a variety of configurations including organization by project, keyword, document, or other grouping.

FIG. 6F depicts an exemplary graphical user interface for displaying an edit profile according to one illustrative embodiment. Edit profile view 400 includes displays of all the indexed data for the user—across all the user's devices. This allows the user to control the privacy or visibility settings for each, or a grouping of, these items. It also allows the user to edit his or her profile to add or update contact information 402, or to preview public profile 500. Note that engagement index score is not user-definable.

FIG. 6G depicts an exemplary graphical user interface for displaying a helper client according to one illustrative embodiment. In the illustrated embodiment, helper client 700 is the primary interface for users to find resources in the form of people, documentation, etc. Project selector 702 displays projects 704 that are either user-created or system-identified. Projects are then broken down by contextual keywords 706, which can include tasks, projects, or simply concepts. Selecting a project 704 or contextual keyword 706 displays list of matching resources 712, 715, 720, 725, and 750. Profile A 712 is an example of an individual who is identified by the system as a relevant resource. The relevant keywords 715, and documents 720 are displayed, as well as information on how to contact the individual 725 and the engagement index 750 indicating the probability of a response. Profile B 714 is an example of an individual who is identified by the system as a relevant resource, but who has chosen to make their keywords and documents private, or is not using the client. For profiles like this, only contact information 725 and engagement index 750 are is shown. However, since the engagement index 750 is context-sensitive, it nevertheless gives the user an indication of usefulness. Users can contact profile-owners (partial and complete) directly from the system using, for example, email, chat, phone, or other electronic means of communication. The user can also choose to include a system-generated introductory message. If a partial profile owner is contacted through the client, the communication includes an invitation 201 to install and run the client. Users can also navigate to the partial profile 300 or full profile 400 of individuals from the results 712, 715, 720, 725, and 750. And a search box 710 can be included to allow users to enter ad-hoc searches.

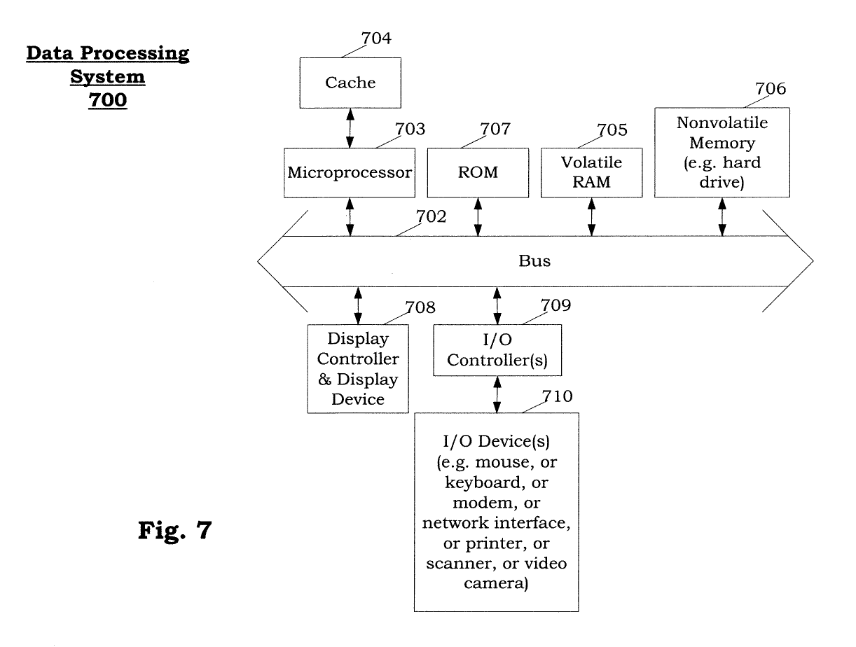

FIG. 7 depicts an illustrative embodiment of a data processing system upon which the methods and apparatuses of the invention may be implemented. Note that while FIG. 7 illustrates various components of a data processing system, it is not intended to represent any particular architecture or manner of interconnecting the components as such details are not germane to the present invention. It will be appreciated that network computers and other data processing systems, which have fewer components or perhaps more components, may also be used. The data processing system of FIG. 7 may, for example, be a workstation, a personal computer (PC) running a MS Windows operating system, or an Apple Macintosh computer. As shown in FIG. 7, the data processing system 701 includes a system bus 702 which is coupled to a microprocessor 703, a read-only memory (ROM) 707, a volatile random access memory (RAM) 705, and other non-volatile memory 706 such as electronic or magnetic disk storage. The microprocessor 703, which may be any processor designed to execute an instruction set, is coupled to cache memory 704 as shown. The system bus 702 interconnects these various components together and also interconnects components 703, 707, 705, and 706 to a display controller and display device 708, and to peripheral devices such as I/O devices 710, keyboards, modems, network interfaces, printers, scanners, video cameras, and other devices which are well known in the art. Generally, I/O devices 710 are coupled to the system bus 702 through an I/O controller 709.

The volatile RAM 705 can be implemented as dynamic RAM (DRAM), which requires power continually in order to refresh or maintain the data in the memory. The non-volatile memory 706 can be a magnetic hard drive or a magnetic optical drive, or an optical drive or DVD RAM, or any other type of memory system that maintains data after power is removed from the system. While FIG. 7 shows that the non-volatile memory 706 is a local device coupled directly to the components of the data processing system, it will be appreciated that the present description may utilize a non-volatile memory remote from the system, such as a network storage device coupled to the data processing system 700 through a network interface such as a modem or Ethernet interface. The system bus 702 may include one or more buses connected to each other through various bridges, controllers or adapters (not shown) as is well known in the art. In one embodiment, the I/O controller 709 includes a USB adapter for controlling USB peripherals, or an IEEE-1394 bus adapter for controlling IEEE-1394 peripherals. Additionally, it will be understood that the various embodiments described herein may be implemented with data processing systems which have more or fewer components than system 700.

Additionally, the data processing systems described herein may be specially constructed for specific purposes, or they may comprise general purpose computers selectively activated or configured by a computer program stored in the computer's memory. Such a computer program may be stored in a computer-readable medium. A computer-readable storage medium can be used to store software instructions, which when executed by a data processing system, cause the system to perform the various methods described herein. A computer-readable storage medium may include any mechanism that provides information in a form accessible by a machine (e.g., a computer, network device, PDA, or any device having a set of one or more processors). For example, a computer-readable storage medium may include any type of disk including floppy disks, hard drive disks (HDDs), solid-state devices (SSDs), optical disks, CD-ROMs, and magnetic-optical disks, ROMs, RAMs, EPROMs, EEPROMs, other flash memory, magnetic or optical cards; or any type of media suitable for storing instructions in an electronic format.

Throughout the foregoing description, for the purposes of explanation, numerous specific details were set forth in order to provide a thorough understanding of the invention. It will be apparent, however, to one skilled in the art that the invention may be practiced without some of these specific details. Although various embodiments which incorporate the teachings of the present description have been shown and described in detail herein, those skilled in the art can readily devise many other varied embodiments that still incorporate these techniques. For example, embodiments of may include various operations as set forth above, or fewer or more operations; or operations in an order different from the order described herein. Further, in foregoing discussion, various components were described as hardware, software, firmware, or combination thereof. In one example, the software or firmware may include processor-executable instructions stored in physical memory and the hardware may include a processor for executing those instructions. Thus, certain elements operating on the same device may share a common processor and common memory. Accordingly, the scope and spirit of the invention should be judged in terms of the claims which follow as well as the legal equivalents thereof.

What is claimed is:

1. A method of automated generation of user profiles organized around a user's expertise or context comprising:
parsing a user's data into a list of keywords or phrases indicating the user's expertise or a context associated with the user;
annotating the list of keywords or phrases with expertise-based or context-based information;
scoring the annotated list of keywords or phrases based on the strength of their relationship with the expertise or context;
promoting concepts that exceed a threshold score for expertise or context; and
indexing the promoted concepts associated into user profile buckets organized by expertise or context to enable finding relevant persons through competence-based or context-based search queries.

2. The method of claim 1, further comprising ranking the user profile based on number and strength of promoted concepts corresponding to the expertise or context.

3. The method of claim 1, wherein the context includes projects, products, or customers the user is associated with.

4. The method of claim 1, wherein the user's expertise includes the user's knowledge and experience, communications, and connections with others within a relevant field.

5. The method of claim 1, further comprising performing competency detection to match the input list of keywords or phrases against a list of competency indicating terms surrounding the keywords or phrases.

6. The method of claim 1, further comprising performing local statistical processing to characterize the usage of a concept by the user.

7. The method of claim 6, wherein the local statistical processing includes:
common filtering of terms mentioned too frequently by the user; and
rare filtering of terms used rarely by the user.

8. The method of claim 1, further comprising performing global statistical processing to statistically characterize the usage of terms or phrases by all users within the context.

9. The method of claim 8, wherein the global statistical processing includes:
generating single-word statistics with the context; and
detecting and extracting relevant names or name variations.

10. The method of claim 1, wherein the scoring includes determining the probability that the keywords or phrases are associated with the expertise or context.

11. The method of claim 1, wherein the scoring involves graded scoring with conditional probabilities directly and in the aggregate.

12. The method of claim 1, wherein promoting concepts includes calculating relative distances between the keywords or phrases and the expertise or context using a distance algorithm.

13. The method of claim 1, further comprising filtering out unwanted user data that is either not relevant to any expertise or not relevant to the context.

14. The method of claim 1, wherein top ranked user profiles form a suggestion pool for a given context and search criteria.

15. The method of claim 2, further comprising receiving search queries from users requesting profile suggestions.

16. The method of claim 15, further comprising matching profiles based on the search context, wherein profile rank assists in providing the best matched profiles first in search results.

17. A linguistic processing pipeline configured for automated generation of user profiles organized around a user's expertise or context comprising:
a linguistic parsing component configured to parse a user's data into a list of keywords or phrases indicating the user's expertise or a context associated with the user;
a competency detection unit configured to annotate the list of keywords or phrases with expertise-based or context-based information;
a scoring component adapted to score the annotated list of keywords or phrases based on the strength of their relationship with the expertise or context;
a promotion service configured to pass or fail concepts based on a threshold score for expertise or context; and
a clustering service to index the promoted concepts associated into user profile buckets organized by the expertise or context to enable finding relevant persons through competence-based or context-based search queries.

18. The linguistic processing pipeline of claim 17, wherein the scoring component ranks the user profile based on number and strength of promoted concepts corresponding to the expertise or context.

19. The linguistic processing pipeline of claim 17, wherein the context includes projects, products, or customers the user is associated with.

20. The linguistic processing pipeline of claim 17, wherein the user's expertise includes the user's knowledge and experience, communications, and connections with others within a relevant field.

21. The linguistic processing pipeline of claim 17, further comprising a competency detection unit adapted to match the input list of keywords or phrases against a list of competency indicating terms surrounding the keywords or phrases.

22. The linguistic processing pipeline of claim 17, further comprising a local statistical processing unit configured to characterize the usage of a concept by the user and a global statistical processing unit configured to statistically characterize the usage of terms or phrases by all users within the context.

23. The linguistic processing pipeline of claim 17, wherein the scoring component is configured to determine the probability that the keywords or phrases are associated with the expertise or context.

24. The linguistic processing pipeline of claim 17, wherein the promotion service is configured to calculate the relative distances between the keywords or phrases and the expertise or context using a distance algorithm.

25. The linguistic processing pipeline of claim 18, further comprising a recommendation service configured to receive search queries from users requesting profile suggestions.

26. The linguistic processing pipeline of claim 25, wherein the recommendation service is further configured to match user profiles based on the search context, wherein profile rank assists in providing the best matched profiles first in search results.

27. A computer-readable storage medium having instructions stored thereon, which when executed by a computer processor, cause the computer to perform a process for automated generation of user profiles organized around a user's expertise or context, the instructions comprising:
instructions to parse a user's data into a list of keywords or phrases indicating the user's expertise or a context associated with the user;
instructions to annotate the list of keywords or phrases with expertise-based or context-based information;
instructions to score the annotated list of keywords or phrases based on the strength of their relationship with the expertise or context;
instructions to promote concepts that exceed a threshold score for the expertise or context; and
instructions to index the promoted concepts associated into user profile buckets organized by expertise or context to enable finding relevant persons through competence-based or context-based search queries.

28. The computer-readable storage medium of claim 27, further comprising instructions to rank the user profile based on number and strength of promoted concepts corresponding to the expertise or context.

29. The computer-readable storage medium of claim 27, further comprising instructions to perform competency detection to match the input list of keywords or phrases against a list of competency indicating terms surrounding the keywords or phrases.

30. The computer-readable storage medium of claim 27, further comprising instructions to perform local statistical processing to characterize the usage of a concept by the user including:
instructions for common filtering of terms mentioned too frequently by the user; and
instructions for rare filtering of terms used rarely by the user.

31. The computer-readable storage medium of claim 27, further comprising instructions to perform global statistical processing to statistically characterize the usage of terms or phrases by all users within the context including:
instructions for generating single-word statistics with the context; and
instructions for detecting and extracting relevant names or name variations.

32. The computer-readable storage medium of claim 27, wherein the instructions to score the annotated list of keywords or phrases include instructions to determine the probability that the keywords or phrases are associated with the expertise or context.

33. The computer-readable storage medium of claim 27, wherein the instructions to promote concepts includes instructions to calculate relative distances between the keywords or phrases and the expertise or context using a distance algorithm.

34. The computer-readable storage medium of claim 27, further comprising instructions to filter out unwanted user data that is either not relevant to any expertise or not relevant to the context.

35. The computer-readable storage medium of claim 27, wherein top ranked user profiles form a suggestion pool for a given context and search criteria.

36. The computer-readable storage medium of claim 28, further comprising instructions to receive search queries from users requesting profile suggestions.

37. The computer-readable storage medium of claim 36, further comprising instructions to match profiles based on the search context.
